(19) United States
(12) Patent Application Publication
(10) Pub. No.: US 2012/0021296 A1
(43) Pub. Date: Jan. 26, 2012

(54) NONAQUEOUS ELECTROLYTE BATTERY AND NONAQUEOUS ELECTROLYTE

(75) Inventors: Yusuke Funada, Fukushima (JP); Shunsuke Saito, Fukushima (JP); Haruo Watanabe, Kanagawa (JP); Tadahiko Kubota, Kanagawa (JP)

(73) Assignee: SONY CORPORATION, Tokyo (JP)

(21) Appl. No.: 13/170,371

(22) Filed: Jun. 28, 2011

(30) Foreign Application Priority Data
Jul. 7, 2010 (JP) 2010-154709

(51) Int. Cl. H01M 10/056

(52) U.S. Cl. 429/300; 429/343

(57) ABSTRACT

A nonaqueous electrolyte battery includes: a positive electrode; a negative electrode; and a nonaqueous electrolyte, wherein the nonaqueous electrolyte contains a solvent, an electrolyte salt, and a polyacid and/or a polyacid compound, and the solvent contains a chain carboxylate with a total carbon number of 4 or more.

### FIELD

The present disclosure relates to a nonaqueous electrolyte battery and a nonaqueous electrolyte. In more detail, the present disclosure relates to a nonaqueous electrolyte battery using a nonaqueous electrolyte containing a chain carbonate.

### BACKGROUND

In recent years, portable electronic appliances such as a camera-integrated VTR (video tape recorder), a mobile phone and a laptop personal computer have widely spread, and it is strongly demanded to realize downsizing, weight reduction and long life thereof. Following this, the development of batteries as a portable power source for electronic appliances, in particular, secondary batteries which are lightweight and from which a high energy density is obtainable is advanced.

Above all, secondary batteries utilizing intercalation and deintercalation of lithium (Li) for a charge/discharge reaction (so-called lithium ion secondary batteries) are widely put into practical use because a high energy density is obtainable as compared with conventional lead batteries and nickel-cadmium batteries which are a nonaqueous electrolytic solution secondary battery. Such a lithium ion secondary battery is provided with an electrolyte together with a positive electrode and a negative electrode.

In particular, laminated batteries using an aluminum laminated film for a package member have a large energy density because of their light weight. Also, in the laminated batteries, when an electrolytic solution is swollen into a polymer, deformation of the laminated battery can be suppressed, and therefore, a laminated polymer battery is also widely used.

The electrolytic solution which is used for nonaqueous electrolyte batteries is constituted mainly of an electrolyte and a nonaqueous solvent. As a main component of the nonaqueous solvent, a cyclic carbonate such as ethylene carbonate and propylene carbonate; a chain carbonate such as dimethyl carbonate, diethyl carbonate and ethyl methyl carbonate; a cyclic carboxylate such as γ-butyrolactone and γ-valerolactone; a chain carboxylate such as ethyl acetate and ethyl butyrate; and so one are used.

As compared with the carbonate, the carboxylate is low in viscosity and high in dielectric constant, and therefore, an enhancement of ion conductivity can be expected. JP-A-2004-241339 proposes to enhance a cycle characteristic by using an electrolytic solution containing a chain carboxylate.

However, as compared with the carbonate, the chain carboxylate is low in boiling point and is easily electrically decomposed. For that reason, in batteries using a chain carboxylate as a nonaqueous solvent, there was involved such a problem that when charge/discharge is repeated under a high-temperature environment, the capacity is deteriorated, or the generation of a gas becomes conspicuous.

In order to improve this problem, JP-A-2009-301954 uses a nonaqueous electrolytic solution containing a chain carboxylate whose total carbon number is restricted to 6 or more, in which a decomposition product is considered to be hardly gasified.

### SUMMARY

However, even in the case of using a nonaqueous electrolytic solution containing a chain carboxylate whose total carbon number is restricted to 6 or more, there was still involved such a problem that when charge/discharge is repeated under a high-temperature environment, the generation of a gas becomes conspicuous.

Thus, it is desirable to provide a nonaqueous electrolyte battery and a nonaqueous electrolyte, each of which when a chain carboxylate is used as a nonaqueous solvent, is able to suppress the deterioration in capacity and the generation of a gas at the time of repeating charge/discharge under a high-temperature environment.

One embodiment of the present disclosure is directed to a nonaqueous electrolyte battery including a positive electrode, a negative electrode and a nonaqueous electrolyte, wherein the nonaqueous electrolyte contains a solvent, an electrolyte salt and a polyacid and/or a polyacid compound, and the solvent contains a chain carboxylate with a total carbon number of 4 or more.

Another embodiment of the present disclosure is directed to a nonaqueous electrolyte battery including a positive electrode, a negative electrode and a nonaqueous electrolyte containing a solvent and an electrolyte salt, wherein the solvent contains a chain carboxylate with a total carbon number of 4 or more, and a coating in a gel form containing an amorphous polyacid and/or polyacid compound having one or more of a polyelement is formed on the negative electrode.

Still another embodiment of the present disclosure is directed to a nonaqueous electrolyte battery including a positive electrode, a negative electrode and a nonaqueous electrolyte containing a solvent and an electrolyte salt, wherein the solvent contains a chain carboxylate with a total carbon number of 4 or more, and a polyacid and/or a polyacid compound is contained in the inside of the battery.

Still yet another embodiment of the present disclosure is directed to a nonaqueous electrolyte including a solvent, an electrolyte salt and a polyacid and/or a polyacid compound, wherein the solvent contains a chain carboxylate with a total carbon number of 4 or more.

In the one embodiment of the present disclosure, the nonaqueous electrolyte contains a chain carboxylate with a total carbon number of 4 or more together with a polyacid and/or a polyacid compound. A coating derived from the polyacid and/or the polyacid compound is formed on the negative electrode by means of charge. According to this, decomposition of the chain carboxylate with a total carbon number of 4 or more is suppressed at the time of charge/discharge under a high-temperature environment, so that the deterioration in capacity and the generation of a gas at the time of repeating charge/discharge under a high-temperature environment can be suppressed.

In the another embodiment of the present disclosure, the solvent contains a chain carboxylate with a total carbon number of 4 or more, and a coating in a gel form containing an amorphous polyacid and/or polyacid compound having one or more kinds of polyelements are formed on the negative electrode. According to this, decomposition of the chain carboxylate with a total carbon number of 4 or more is suppressed at the time of charge/discharge under a high-temperature environment, so that the deterioration in capacity and the generation of a gas at the time of repeating charge/discharge under a high-temperature environment can be suppressed.

In the still another embodiment of the present disclosure, a polyacid and/or a polyacid compound is contained in the inside of the battery, and the solvent contains a chain carboxylate with a total carbon number of 4 or more. A coating derived from the polyacid and/or the polyacid compound is formed on the negative electrode by means of charge. According to this, decomposition of the chain carboxylate with a total carbon number of 4 or more is suppressed at the time of charge/discharge under a high-temperature environment, so that the deterioration in capacity and the generation of a gas at the time of repeating charge/discharge under a high-temperature environment can be suppressed.

In the still yet another embodiment of the present disclosure, the nonaqueous electrolyte contains a chain carboxylate with a total carbon number of 4 or more together with a polyacid and/or a polyacid compound. According to this, when used for electrochemical devices such as batteries, decomposition of the chain carboxylate with a total carbon number of 4 or more is suppressed at the time of charge/discharge under a high-temperature environment, so that the deterioration in capacity and the generation of a gas at the time of repeating charge/discharge under a high-temperature environment can be suppressed.

According to the embodiments of the present disclosure, the deterioration in capacity and the generation of a gas at the time of repeating charge/discharge under a high-temperature environment can be suppressed.

### BRIEF DESCRIPTION OF THE DRAWINGS

FIG. 1 is an exploded perspective view showing an example of a configuration of a nonaqueous electrolyte battery according to an embodiment of the present disclosure.

FIG. 2 is a sectional view along an I-I line of a wound electrode body in FIG. 1.

FIG. 3 is an SEM photograph of a negative electrode surface.

FIG. 4 is an example of a secondary ion spectrum by the time-of-flight secondary ion mass spectrometry (ToF-SIMS) on a negative electrode surface on which a deposit is deposited by the addition of silicotungstic acid to the inside of a battery system.

FIG. 5 is an example of a radial structure function of a W-O bond obtained by the Fourier transformation of a spectrum by the X-ray absorption fine structure (XAFS) analysis on a negative electrode surface on which a deposit is deposited by the addition of silicotungstic acid to the inside of a battery system.

FIG. 6 is a sectional view showing an example of a configuration of a nonaqueous electrolyte battery according to an embodiment of the present disclosure.

FIG. 7 is a sectional view showing enlargedly a part of a wound electrode body.

FIG. 8 is an exploded perspective view showing an example of a configuration of a nonaqueous electrolyte battery according to an embodiment of the present disclosure.

FIG. 9 is a perspective view showing an example of an appearance of a battery element.

FIG. 10 is a sectional view showing an example of a configuration of a battery element.

FIG. 11 is a plan view showing an example of a shape of a positive electrode.

FIG. 12 is a plan view showing an example of a shape of a negative electrode.

FIG. 13 is a plan view showing an example of a shape of a separator.

FIG. 14 is a sectional view showing an example of a configuration of a battery element which is used in a nonaqueous electrolyte battery according to an embodiment of the present disclosure.

### DETAILED DESCRIPTION

Embodiments according to the present disclosure are hereunder described by reference to the accompanying drawings. The description is made in the following order.

1. First embodiment (a first example of a nonaqueous electrolyte battery)

2. Second embodiment (a second example of a nonaqueous electrolyte battery)

3. Third embodiment (a third example of a nonaqueous electrolyte battery)

4. Fourth embodiment (a fourth example of a nonaqueous electrolyte battery)

5. Fifth embodiment (a fifth example of a nonaqueous electrolyte battery)

6. Other embodiments (modification examples)

### 1. First Embodiment

### Configuration of Battery

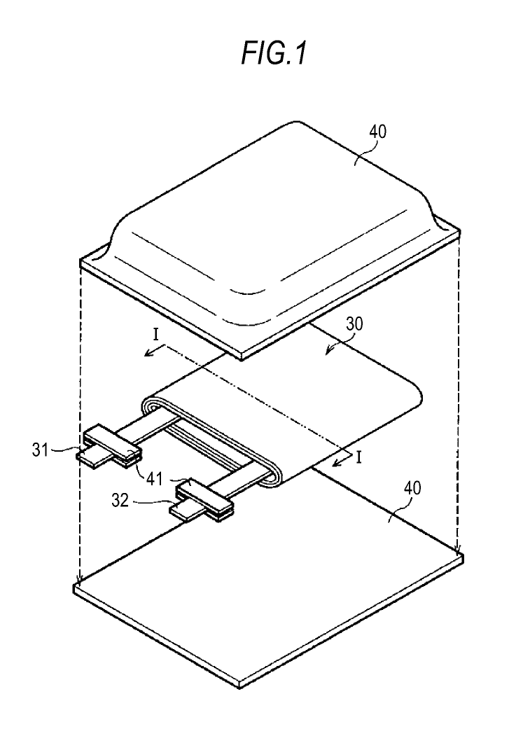

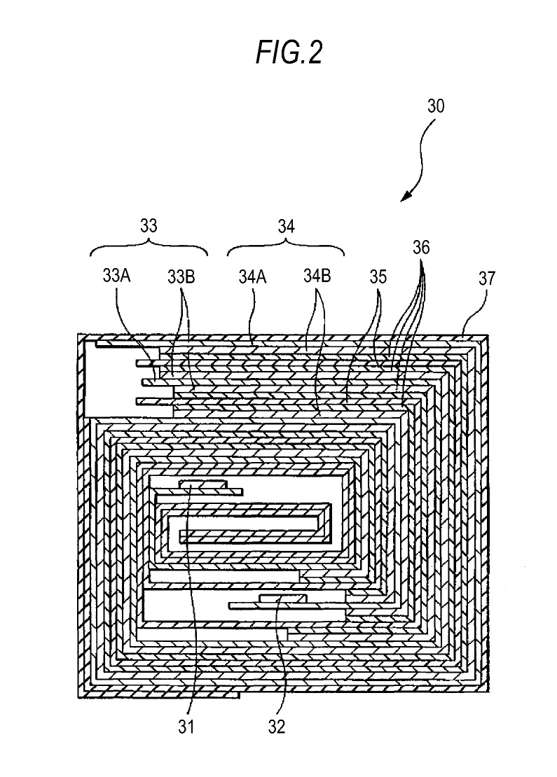

A nonaqueous electrolyte battery according to a first embodiment of the present disclosure is described. FIG. 1 illustrates an exploded perspective configuration of a nonaqueous electrolyte battery according to the first embodiment of the present disclosure; and FIG. 2 shows enlargedly a section along an I-I line of a wound electrode body 30 shown in FIG. 1.

This nonaqueous electrolyte battery has a configuration in which the wound electrode body 30 having mainly a positive electrode lead 31 and a negative electrode lead 32 installed therein is housed in the inside of a film-shaped package member 40. A battery structure using this film-shaped package member 40 is called a laminated film type.

Each of the positive electrode lead 31 and the negative electrode lead 32 is, for example, led out from the inside of the package member 40 toward the outside in the same direction. The positive electrode lead 31 is, for example, constituted of a metal material such as aluminum, and the negative electrode lead 32 is, for example, constituted of a metal material such as copper, nickel and stainless steel. Such a metal material is, for example, formed in a thin plate state or a network state.

The package member 40 is, for example, constituted of an aluminum laminated film obtained by sticking a nylon film, an aluminum foil and a polyethylene film in this order. For example, this package member 40 has a structure in which respective outer edges of the two rectangular aluminum laminated films are allowed to adhere to each other by means of fusion or with an adhesive in such a manner that the polyethylene film is disposed opposing to the wound electrode body 30.

A contact film 41 is inserted between the package member 40 and each of the positive electrode lead 31 and the negative electrode lead 32 for the purpose of preventing invasion of the outside air from occurring. This contact film 41 is constituted of a material having adhesion to each of the positive electrode lead 31 and the negative electrode lead 32. Examples of such a material include polyolefin resins such as polyethylene, polypropylene, modified polyethylene and modified polypropylene.

Incidentally, the package member 40 may also be constituted of a laminated film having other lamination structure, or constituted of a polymer film such as polypropylene or a metal film, in place of the foregoing aluminum laminated film.

FIG. 2 shows a sectional configuration along an I-I line of the wound electrode body 30 shown in FIG. 1. This wound electrode body 30 is prepared by laminating a positive electrode 33 and a negative electrode 34 via a separator 35 and an electrolyte 36 and winding the laminate, and an outermost peripheral part thereof is protected by a protective tape 37.

### (Positive Electrode)

The positive electrode 33 is, for example, one in which a positive electrode active material layer 33B is provided on the both surfaces of a positive electrode collector 33A having a pair of surfaces opposing to each other. However, the positive electrode active material layer 33B may be provided on only one surface of the positive electrode collector 33A.

The positive electrode collector 33A is, for example, constituted of a metal material such as aluminum, nickel and stainless steel.

The positive electrode active material layer 33B contains, as a positive electrode active material, one or two or more kinds of positive electrode materials capable of intercalating and deintercalating lithium and may further contain other materials such as a binder and a conductive agent, if desired.

As the positive electrode material capable of intercalating and deintercalating lithium, for example, lithium complex oxides such as lithium cobaltate, lithium nickelate and solid solutions thereof {for example, Li(NiₓCO_{y}Mn_{z})O₂ (values of x, y and z are satisfied with relations of (0<x<1), (0<y<1), (0≦z<1) and (x+y+z)=1, respectively), Li(NiₓCO_{y}Al_{z})O₂ (values of x, y and z are satisfied with relations of (0<x<1), (0<y<1), (0≦z<1) and (x+y+z)=1, respectively), etc.}; manganese spinel (LiMn₂O₄) and solid solutions thereof {for example, Li(Mn₂₋ᵥNiᵥ)O₄ (a value of v is satisfied with a relation of (v<2)), etc.}; and phosphate compounds having an olivine structure, such as lithium iron phosphate (LiFePO₄) and LiₓFe_{1-y}M2_{y}PO₄ (wherein M2 represents at least one member selected from the group consisting of manganese (Mn), nickel (Ni), cobalt (Co), zinc (Zn) and magnesium (Mg); and x is a value falling within the range of (0.9≦x≦1.1)), and y is a value falling within the range of (0≦y<1)), are preferable. This is because a high energy density is obtainable.

Also, examples of the positive electrode material capable of intercalating and deintercalating lithium include oxides such as titanium oxide, vanadium oxide and manganese dioxide; disulfides such as iron disulfide, titanium disulfide and molybdenum sulfide; sulfur; and conductive polymers such as polyaniline and polythiophene.

As a matter of course, the positive electrode material capable of intercalating and deintercalating lithium may be other material than those exemplified above.

Examples of the binder include synthetic rubbers such as a styrene butadiene based rubber, a fluorocarbon based rubber and an ethylene propylene diene based rubber; and polymer materials such as polyvinylidene fluoride. These materials may be used singly or in admixture of plural kinds thereof.

Examples of the conductive agent include carbon materials such as graphite and carbon black. These materials are used singly or in admixture of plural kinds thereof.

### (Negative Electrode)

The negative electrode 34 is, for example, one in which a negative electrode active material layer 34B is provided on the both surfaces of a negative electrode collector 34A having a pair of surfaces. However, the negative electrode active material layer 34B may be provided on only one surface of the negative electrode collector 34A.

The negative electrode collector 34A is, for example, constituted of a metal material such as copper, nickel and stainless steel.

The negative electrode active material layer 34B contains, as a negative electrode active material, one or two or more kinds of negative electrode materials capable of intercalating and deintercalating lithium and may also contain other materials such as a binder and a conductive agent, if desired. Incidentally, as the binder and the conductive agent, the same materials as those described for the positive electrode can be used, respectively.

Examples of the negative electrode material capable of intercalating and deintercalating lithium include carbon materials. Examples of such a carbon material include easily graphitized carbon, hardly graphitized carbon with a (002) plane interval of 0.37 nm or more and graphite with a (002) plane interval of not more than 0.34 nm. More specifically, there are exemplified pyrolytic carbons, cokes, vitreous carbon fibers, organic polymer compound baked materials, active carbon and carbon blacks. Of these, examples of the cokes include pitch coke, needle coke and petroleum coke. The organic polymer compound baked material as referred to herein is a material obtained through carbonization by baking a phenol resin, a furan resin or the like at an appropriate temperature. The carbon material is preferable because a change in a crystal structure following the intercalation and deintercalation of lithium is very small, and therefore, a high energy density is obtainable, an excellent cycle characteristic is obtainable, and the carbon material also functions as a conductive agent. Incidentally, the shape of the carbon material may be any of a fibrous shape, a spherical shape, a granular shape or a flaky shape.

In addition to the foregoing carbon materials, examples of the negative electrode material capable of intercalating and deintercalating lithium include a material capable of intercalating and deintercalating lithium and containing, as a constituent element, at least one member selected from the group consisting of metal elements and semi-metal elements. This is because a high energy density is obtainable. Such a negative electrode material may be a simple substance, an alloy or a compound of a metal element or a semi-metal element. Also, a material having one or two or more kinds of phases in at least a part thereof may be used. Incidentally, the “alloy” as referred to herein includes, in addition to alloys composed of two or more kinds of metal elements, alloys containing one or more kinds of metal elements and one or more kinds of semi-metal elements. Also, the “alloy” may contain a non-metal element. Examples of its texture include a solid solution, a eutectic (eutectic mixture), an intermetallic compound and one in which two or more kinds thereof coexist.

Examples of the metal element or semi-metal element include a metal element or a semi-metal element capable of forming an alloy together with lithium. Specific examples thereof include magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc (Zn), hafnium (Hf), zirconium (Zr), yttrium (Y), palladium (Pd) and platinum (Pt). Of these, at least one member selected from silicon and tin is preferable, and silicon is more preferable. This is because silicon and tin have large capability to intercalate and deintercalate lithium, so that a high energy density is obtainable.

Examples of the negative electrode material containing at least one member selected from silicon and tin include a simple substance, an alloy or a compound of silicon; a simple substance, an alloy or a compound of tin; and a material having one kind or two or more kinds of phases in at least a part thereof.

Examples of alloys of silicon include alloys containing, as a second constituent element other than silicon, at least one member selected from the group consisting of tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb) and chromium (Cr). Examples of alloys of tin include alloys containing, as a second constituent element other than tin (Sn), at least one member selected from the group consisting of silicon (Si), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb)and chromium (Cr).

Examples of compounds of silicon or compounds of tin include compounds containing oxygen (O) or carbon (C), and these compounds may further contain the foregoing second constituent element in addition to silicon (Si) or tin (Sn).

As the negative electrode material containing at least one member selected from silicon (Si) and tin (Sn), for example, a material containing tin (Sn) as a first constituent element and in addition to this tin (Sn), a second constituent element and a third constituent element is especially preferable. As a matter of course, this negative electrode material may be used together with the foregoing negative electrode material. The second constituent element is at least one member selected from the group consisting of cobalt (Co), iron (Fe), magnesium (Mg), titanium (Ti), vanadium (V), chromium (Cr), manganese (Mn), nickel (Ni), copper (Cu), zinc (Zn), gallium (Ga), zirconium (Zr), niobium (Nb), molybdenum (Mo), silver (Ag), indium (In), cerium (Ce), hafnium (Hf), tantalum (Ta), tungsten (W), bismuth (Bi) and silicon (Si). The third constituent element is at least one member selected from the group consisting of boron (B), carbon (C), aluminum (Al) and phosphorus (P). This is because when the second constituent element and the third constituent element are contained, a cycle characteristic is enhanced.

Above of all, the negative electrode material is preferably an SnCoC-containing material containing tin (Sn), cobalt (Co) and carbon (C) as constituent elements and having a content of carbon (C) in the range of 9.9% by mass or more and not more than 29.7% by mass and a proportion of cobalt (Co) to the total sum of tin (Sn) and cobalt (Co) (Co/(Sn+Co)) in the range of 30% by mass or more and not more than 70% by mass. This is because in the foregoing composition range, not only a high energy density is obtainable, but an excellent cycle characteristic is obtainable.

This SnCoC-containing material may further contain other constituent elements, if desired. As other constituent elements, for example, silicon (Si), iron (Fe), nickel (Ni), chromium (Cr), indium (In), niobium (Nb), germanium (Ge), titanium (Ti), molybdenum (Mo), aluminum (Al), phosphorus (P), gallium (Ga) and bismuth (Bi) are preferable. The SnCoC-containing material may contain two or more kinds of these elements. This is because a capacity characteristic or a cycle characteristic is more enhanced.

Incidentally, the SnCoC-containing material has a phase containing tin (Sn), cobalt (Co) and carbon (C), and it is preferable that this phase has a low crystalline or amorphous structure. Also, in the SnCoC-containing material, it is preferable that at least a part of carbon as the constituent element is bound to a metal element or a semi-metal element as other constituent element. This is because though it may be considered that a lowering of the cycle characteristic is caused due to aggregation or crystallization of tin (Sn) or the like, when carbon is bound to other elements, such aggregation or crystallization is suppressed.

Examples of a measurement method for examining the binding state of elements include X-ray photoelectron spectroscopy (XPS). In this XPS, so far as graphite is concerned, a peak of the is orbit (C1s) of carbon appears at 284.5 eV in an energy-calibrated apparatus such that a peak of the 4f orbit of a gold atom (Au4f) is obtained at 84.0 eV. Also, so far as surface contamination carbon is concerned, a peak of the is orbit (C1s) of carbon appears at 284.8 eV. On the contrary, in the case where a charge density of the carbon element is high, for example, in the case where carbon is bound to a metal element or a semi-metal element, the peak of C1s appears in a lower region than 284.5 eV. That is, in the case where a peak of a combined wave of C1s obtained regarding the SnCoC-containing material appears in a lower region than 284.5 eV, at least a part of carbon (C) contained in the SnCoC-containing material is bound to a metal element or a semi-metal element as other constituent elements.

Incidentally, in the XPS measurement, for example, the peak of C1s is used for correcting the energy axis of a spectrum. In general, since surface contamination carbon exists on the surface, the peak of C1s of the surface contamination carbon is fixed at 284.8 eV, and this peak is used as an energy reference. In the XPS measurement, since a waveform of the peak of C1s is obtained as a form including the peak of the surface contamination carbon and the peak of carbon in the SnCoC-containing material, the peak of the surface contamination carbon and the peak of the carbon in the SnCoC-containing material are separated from each other by means of analysis using, for example, a commercially available software program. In the analysis of the waveform, the position of a main peak existing on the side of the lowest binding energy is used as an energy reference (284.8 eV).

Also, examples of the negative electrode material capable of intercalating and deintercalating lithium include metal oxides and polymer compounds, each of which is capable of intercalating and deintercalating lithium. Examples of the metal oxide include iron oxide, ruthenium oxide and molybdenum oxide; and examples of the polymer compound include polyacetylene, polyaniline and polypyrrole.

Furthermore, the negative electrode material capable of intercalating and deintercalating lithium may be a material containing an element capable of forming a complex oxide with lithium, such as titanium.

As a matter of course, metallic lithium may be used as the negative electrode active material, thereby depositing and dissolving the metallic lithium. It is also possible to deposit and dissolve magnesium or aluminum other than lithium.

The negative electrode active material layer 34B may be, for example, formed by any of a vapor phase method, a liquid phase method, a spraying method, a baking method or a coating method, or a combined method of two or more kinds of these methods. Examples of the vapor phase method include a physical deposition method and a chemical deposition method, specifically a vacuum vapor deposition method, a sputtering method, an ion plating method, a laser abrasion method, a thermal chemical vapor deposition (CVD) method and a plasma chemical vapor deposition method. As the liquid phase method, known techniques such as electrolytic plating and non-electrolytic plating can be adopted. The baking method as referred to herein is, for example, a method in which after a granular negative electrode active material is mixed with a binder and the like, the mixture is dispersed in a solvent and coated, and the coated material is then heat treated at a higher temperature than a melting point of the binder, etc. As to the baking method, known techniques can be utilized, too, and examples thereof include an atmospheric baking method, a reaction baking method and a hot press baking method.

In the case of using metallic lithium as the negative electrode active material, the negative electrode active material layer 34B may be previously provided at the time of assembling. However, it may be absent at the time of assembling but may be constituted of a lithium metal deposited at the time of charge. Also, the negative electrode collector 34A may be omitted by utilizing the negative electrode active material layer 34B as a collector, too.

### (Separator)

The separator 35 partitions the positive electrode 33 and the negative electrode 34 from each other and allows a lithium ion to pass therethrough while preventing a short circuit of the current due to the contact between the both electrodes. This separator 35 is constituted of, for example, a porous film made of a synthetic resin such as polytetrafluoroethylene, polypropylene and polyethylene; a porous film made of a ceramic; or the like, and a laminate of two or more kinds of these porous films may also be used.

### (Electrolyte)

The electrolyte 36 contains an electrolytic solution and a polymer compound having swollen upon absorbing the electrolytic solution and is an electrolyte in a so-called gel form. In this electrolyte in a gel form, the electrolytic solution is held by the polymer compound. The electrolyte in a gel form is preferable because not only a high ion conductivity is obtainable, but liquid leakage is prevented from occurring.

### (Electrolytic Solution)

The electrolytic solution contains a solvent, an electrolyte salt and a heteropolyacid and/or a heteropolyacid compound. The heteropolyacid and/or the heteropolyacid compound is previously added to the electrolytic solution. According to this, the electrolytic solution contains the heteropolyacid and/or the heteropolyacid compound dissolved in the solvent before the charge/discharge.

### (Solvent)

The solvent contains a chain carboxylate with a total carbon number of 4 or more. As for the chain carboxylate with a total carbon number of 4 or more, from the viewpoints of reduction of the viscosity of the electrolytic solution and heat stability of the chain carboxylate, a chain carboxylate with a total carbon number of 4 or more and not more than 8 is preferable, and a chain carboxylate with a total carbon number of 4 or more and not more than 7 is more preferable. This is because when the total carbon number of the chain carboxylate is less than 4, decomposition of the chain carboxylate at the time of charge/discharge under a high-temperature environment is conspicuous, so that a decomposition suppressing effect due to the heteropolyacid and/or the heteropolyacid compound is surpassed; whereas when the total carbon number of the chain carboxylate exceeds 8, the viscosity of the electrolytic solution increases, and following this, the mobility of the heteropolyacid and/or the heteropolyacid compound decreases so that it is not uniformly diffused over the negative electrode, and a coating on the negative electrode surface produced by the decomposition of the heteropolyacid and/or the heteropolyacid compound as described later is heterogeneously formed. Specific examples of this chain carboxylate include a chain carboxylate represented by the following formula (1).

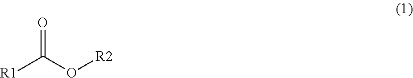

In the formula (1), each of R1 and R2 independently represents a hydrocarbon group. The hydrocarbon group may be branched. A total sum of the carbon number of R1 and R2 is 3 or more.

In the formula (1), examples of the hydrocarbon group include a saturated hydrocarbon group and an unsaturated hydrocarbon group. From the viewpoint of reduction of the viscosity of the electrolytic solution, the total sum of the carbon number of R1 and R2 is preferably not more than 6.

More specifically, examples of the chain carboxylate include acetates, propionates, butyrates, isobutyrates, 2-methylbutyrates, valerates and isovalerates. Still more specifically, examples of the chain carboxylate include ethyl acetate, propyl acetate, butyl acetate, sec-butyl acetate, isobutyl acetate, tert-butyl acetate, amyl acetate, isoamyl acetate, methyl propionate, ethyl propionate, propyl propionate, isopropyl propionate, butyl propionate, isobutyl propionate, methyl butyrate, ethyl butyrate, ethyl isobutyrate, ethyl 2-methylbutyrate, methyl valerate, ethyl valerate, methyl isovalerate, propyl isovalerate, ethyl caproate, butyl butyrate and butyl isobutyrate.

The solvent may also contain other solvent together with the chain carboxylate with a total carbon number of 4 or more.

### (Other Solvent)

Examples of other solvent include nonaqueous solvents, for example, carbonate based solvents such as ethylene carbonate, propylene carbonate, butylene carbonate, vinylene carbonate, dimethyl carbonate, ethyl methyl carbonate and diethyl carbonate; lactone based solvents such as γ-butyrolactone, γ-valerolactone, δ-valerolactone and ∈-caprolactone; ether based solvents such as 1,2-dimethoxyethane, 1-ethoxy-2-methoxyethane, 1,2-diethoxyethane, tetrahydrofuran and 2-methyltetrahydrofuran; nitrile based solvents such as acetonitrile; sulfolane based solvents; phosphoric acids; phosphate solvents; and nonaqueous solvents such as pyrrolidones. The solvent may be used singly or in admixture of two or more kinds thereof.

Also, the other solvents may contain a compound obtained by fluorinating a part or the whole of hydrogens of a cyclic carbonate or a chain carbonate. Examples of the fluorinated compound include 4-fluoro-1,3-dixolan-2-one (FEC) and 4,5-difluoro-1,3-dioxolan-2-one (DFEC).

### (Content)

A content of the chain carboxylate compound with a total carbon number of 4 or more is preferably 0.1% by mass or more and not more than 40% by mass, and more preferably 5% by mass or more and not more than 40% by bass relative to the whole of solvents constituting the electrolytic solution. This is because when the content of the chain carboxylate compound with a total carbon number of 4 or more is less than 0.1% by mass, the effect for reducing the viscosity of the electrolytic solution is not sufficiently obtainable; whereas when the content of the chain carboxylate compound with a total carbon number of 4 or more exceeds 40% by mass, the decomposition amount of the chain carboxylate at the time of charge/discharge under a high-temperature environment becomes high, so that a decomposition suppressing effect by the heteropolyacid and/or the heteropolyacid compound is surpassed.

### (Electrolyte Salt)

The electrolyte salt contains, for example, one or two or more kinds of light metal salts such as a lithium salt. Examples of the lithium salt include inorganic lithium salts such as lithium hexafluorophosphate (LiPF₆), lithium tetrafluoroborate (LiBF₄), lithium hexafluoroarsenate (LiAsF₆), lithium hexafluoroantimonate (LiSbF₆), lithium perchlorate (LiClO₄) and lithium tetrachloroaluminate (LiAlCl₄). Also, examples of the lithium salt include lithium salts of perfluoroalkanesulfonic acid derivatives such as lithium trifluoromethanesulfonate (CF₃SO₃Li), lithium bis(trifluoromethanesulfone)imide ((CF₃SO₂)₂NLi), lithium bis(pentafluoroethanesulfone)imide ((C₂F₅SO₂)₂NLi) and lithium tris (trifluoromethanesulfone) methide ((CF₃SO₂)₃CLi).

(Heteropolyacid and/or Heteropolyacid Compound)

The heteropolyacid and/or the heteropolyacid compound is a condensate of two or more kinds of oxoacid. The heteropolyacid and/or the heteropolyacid compound is preferably a compound having a structure in which a heteropolyacid ion thereof is easily soluble in the solvent of the battery, such as a Keggin structure, an Anderson structure, a Dawson structure and a Preyssler structure. Above all, a compound having a Keggin structure is more preferable because it is more easily soluble in the solvent.

Examples of the heteropolyacid and/or the heteropolyacid compound include heteropolyacids and/or heteropolyacid compounds having a polyatom selected from the following element group (a); and heteropolyacids and/or heteropolyacid compounds having a polyatom selected from the following element group (a), in which a part of the polyatoms is substituted with at least anyone element selected from the following element group (b).

Element group (a): Mo, W, Nb, V

Element group (b): Ti, Cr, Mn, Fe, Co, Ni, Cu, Zn, Ga, Zr, Tc, Rh, Cd, In, Sn, Ta, Re, Tl, Pb

Also, examples of the heteropolyacid and/or the heteropolyacid compound include heteropolyacids and/or heteropolyacid compounds having a hetero atom selected from the following element group (c); and heteropolyacids and/or heteropolyacid compounds having a hetero atom selected from the following element group (c), in which a part of the hetero atoms is substituted with at least any one element selected from the following element group (d).

Element group (c): B, Al, Si, P, Cr, Mn, Fe, Co, Ni, Cu, Zn, Ge, As

Element group (d): H, Be, B, C, Na, Al, Si, P, S, Ti, V, Cr, Mn, Fe, Co, Ni, Cu, Zn, Ga, Ge, As, Se, Zr, Rh, Sn, Sb, Te, I, Re, Pt, Bi, Ce, Th, U, Np

Examples of the heteropolyacid and/or the heteropolyacid compound include heteropolyacids and/or heteropolyacid compounds represented by any one of the following formulae (A) to (D).

Anderson structure: HₓA_{y}[BD₆O₂₄].zH₂O Formula (A)

In the formula (A), x, y and z are values falling within the ranges of (0≦x≦8), (0≦y≦8) and (0≦z≦50), respectively, provided that at least one of x and y is not 0.

Keggin structure: HₓA_{y}[BD₁₂O₄₀].zH₂O Formula (B)

In the formula (B), x, y and z are values falling within the ranges of (0≦x≦4), (0≦y≦4) and (0≦z≦50), respectively, provided that at least one of x and y is not 0.

Dawson structure: HₓA_{y}[B₂D₁₈O₆₂].zH₂O Formula (C)

In the formula (C), x, y and z are values falling within the ranges of (0≦x≦8), (0≦y≦8) and (0≦z≦50), respectively, provided that at least one of x and y is not 0.

Preyssler structure: HₓA_{y}[B₅D₃₀O₁₁₀].zH₂O Formula (D)

In the formula (D), x, y and z are values falling within the ranges of (0≦x≦15), (0≦y≦15) and (0≦z≦50), respectively, provided that at least one of x and y is not 0.

Incidentally, in the foregoing formulae (A) to (D), A represents lithium (Li), sodium (Na), potassium (K), rubidium (Rb), cesium (Cs), magnesium (Mg), calcium (Ca), aluminum (Al), ammonium (NH₄), an ammonium salt or a phosphonium salt; B represents phosphorus (P), silicon (Si), arsenic (As) or germanium (Ge); and D is at least one element selected from the group consisting of titanium (Ti), vanadium (V), chromium (Cr), manganese (Mn), iron (Fe), cobalt (Co), nickel (Ni), copper (Cu), zinc (Zn), gallium (Ga), zirconium (Zr), niobium (Nb), molybdenum (Mo), technetium (Tc), rhodium (Rh), cadmium (Cd), indium (In), tin (Sn), tantalum (Ta), tungsten (W), rhenium (Re) and thallium (Tl).

More specifically, for example, a compound represented by the following formula (I) is exemplified as the heteropolyacid and/or the heteropolyacid compound. The compound represented by the formula (I) is a heteropolyacid and/or a heteropolyacid compound in which a heteropolyacid ion thereof takes a Keggin structure and is preferable because it is easily soluble in the electrolytic solution.

Aₓ[BD₁₂O₄₀].yH₂O Formula (1)

In the formula (I), A represents Li, Na, K, Rb, Cs, Mg, Ca, Al, NH₄, a quaternary ammonium salt or a phosphonium salt; B represents P, Si, As or Ge; D represents at least one element selected from the group consisting of Ti, V, Cr, Mn, Fe, Co, Ni, Cu, Zn, Ga, Zr, Nb, Mo, Tc, Rh, Cd, In, Sn, Ta, W, Re and Tl; and x and y are values falling within the ranges of (0≦x≦7) and (0≦y≦50), respectively.

More specifically, examples of the heteropolyacid include heteropolytungstic acids such as phosphotungstic acid (H₃PW₁₂O₄₀) and silicotungstic acid (H₄SiW₁₂O₄₀); and heteropolymolybdic acids such as phosphomolybdic acid (H₃PMo₁₂O₄₀) and silicomolybdic acid (H₄SiMo₁₂O₄₀). The heteropolyacid may also be a heteropolyacid hydrate such as phosphomolybdic acid 30-hydrate (H₃[PMo₁₂O₄₀].30H₂O), silicomolybdic acid 30-hydrate (H₄[SiMo₁₂O₄₀].30H₂O), phosphotungstic acid 30-hydrate (H₃[PW₁₂O₄₀].30H₂O) silicotungstic acid 30-hydrate (H₄[SiW₁₂O₄₀].30H₂O), phosphomolybdic acid heptahydrate (H₃[PMo₁₂O₄₀].7H₂O), silicomolybdic acid heptahydrate (H₄[SiMo₁₂O₄₀].7H₂O), phosphotungstic acid heptahydrate (H₃[PW₁₂O₄₀].7H₂O), silicotungstic acid heptahydrate (H₄[SiW₁₂O₄₀].7H₂O) and lithium silicotungstate (Li₄[SiW₁₂O₄₀]).

Examples of the heteropolyacid compound include heteropolytungstic acid compounds such as sodium silicotungstate, sodium phosphotungstate and ammonium phosphotungstate. Also, examples of the heteropolyacid compound include heteropolymolybdic acid compounds such as sodium phosphomolybdate and ammonium phosphomolybdate.

Also, examples of the heteropolyacid containing plural kinds of polyelements include phosphovanadomolybdic acid (H₄PMo₁₁VO₄₀) phosphotungstomolybdic acid, silicovanadomolybdic acid and silicotungstomolybdic acid.

It is preferable that the heteropolyacid compound has a cation, for example, Li⁺, Na⁺, K⁺, Rb⁺, Cs⁺, R₄N⁺, R₄P⁺, etc., wherein R is H or a hydrocarbon group having not more than 10 carbon atoms. Also, the cation is more preferably Li⁺, tetra-n-butylammonium or tetra-n-butylphosphonium.

Examples of such a heteropolyacid compound include heteropolytungstic acid compounds such as sodium silicotungstate, sodium phosphotungstate, ammonium phosphotungstate and a silicotungstic acid tetra-tetra-n-butylphosphonium salt. Also, examples of the heteropolyacid compound include heteropolymolybdic acid compounds such as sodium phosphomolybdate, ammonium phosphomolybdate and a phosphomolybdic acid tri-tetra-n-butylammonium salt. Furthermore, examples of a compound containing plural polyacids include a material such as a phosphotungstomolybdic acid tri-tetra-n-ammonium salt.

Such a heteropolyacid or heteropolyacid compound may be used in admixture of two or more kinds thereof. Such a heteropolyacid or heteropolyacid compound is easily soluble in the solvent, is stable in the battery and is hard to give adverse influences such as a reaction with other materials.

A polyacid and/or a polyacid compound exhibiting solubility in the electrolytic solution may be used in place of the heteropolyacid and/or the heteropolyacid compound or together with the heteropolyacid and/or the heteropolyacid compound. Examples of such a polyacid and/or polyacid compound include tungstic(VI) acid and molybdic(VI) acid. Also, there are exemplified tungstic anhydride and molybdic anhydride and hydrates thereof. Examples of the hydrate which can be used include orthotungstic acid (H₂WO₄) that is tungstic acid monohydrate (WO₃.H₂O), molybdic acid dihydrate (H₄MoO₅, H₂MoO₄.H₂O or MoO₃.2H₂O) and orthomolybdic acid (H₂MoO₄) that is molybdic acid monohydrate (MoO₃.H₂O). Also, tungstic anhydride (WO₃) having a smaller hydrogen content than metatungstic acid, paratungstic acid and the like that are an isopolyacid of the foregoing hydrate, and ultimately having a zero hydrogen content; molybdic anhydride (MoO₃) having a smaller hydrogen content than metamolybdic acid, paramolybdic acid and the like that are an isopolyacid of the foregoing hydrate, and ultimately having a zero hydrogen content; and the like can be used.

(Behavior of Heteropolyacid and/or Heteropolyacid Compound by Charge)

A behavior of the heteropolyacid and/or the heterocyclic compound by charge of the nonaqueous electrolyte battery in which the heteropolyacid and/or the heterocyclic compound has been previously added to the electrolytic solution is described.

In the nonaqueous electrolyte battery using an electrolytic solution having a heteropolyacid and/or a heteropolyacid compound previously added thereto, a coating derived from such a compound is formed on the negative electrode 34 by initial charge or preliminary charge. That is, the heteropolyacid and/or the heteropolyacid compound in the electrolytic solution is electrolyzed by initial charge or preliminary charge, whereby a compound derived from the heteropolyacid and/or the heteropolyacid compound is deposited on the surface of the negative electrode 34 to form a coating.

The compound deposited on the negative electrode 34, which is derived from the heteropolyacid and/or the heteropolyacid compound, includes a polyacid and/or a polyacid compound having one or more kinds of polyatoms, or a reduced material of a polyacid and/or a polyacid compound having one or more kinds of polyatoms, each of which is produced by the electrolysis of the heteropolyacid and/or the heteropolyacid compound and is poorer in solubility than the heteropolyacid and/or the heteropolyacid compound, or the like.

Specifically, the polyacid and/or the polyacid compound deposited on the negative electrode surface is amorphous. For example, this amorphous polyacid and/or polyacid compound absorbs the nonaqueous electrolytic solution and exists as a coating in a gel form on the negative electrode surface. For example, a deposit containing the polyacid and/or the polyacid compound grows in a three-dimensional network structure and deposits at the time of preliminary charge or at the time of charge. Also, at least a part of the deposited polyacid and/or polyacid compound may be reduced.

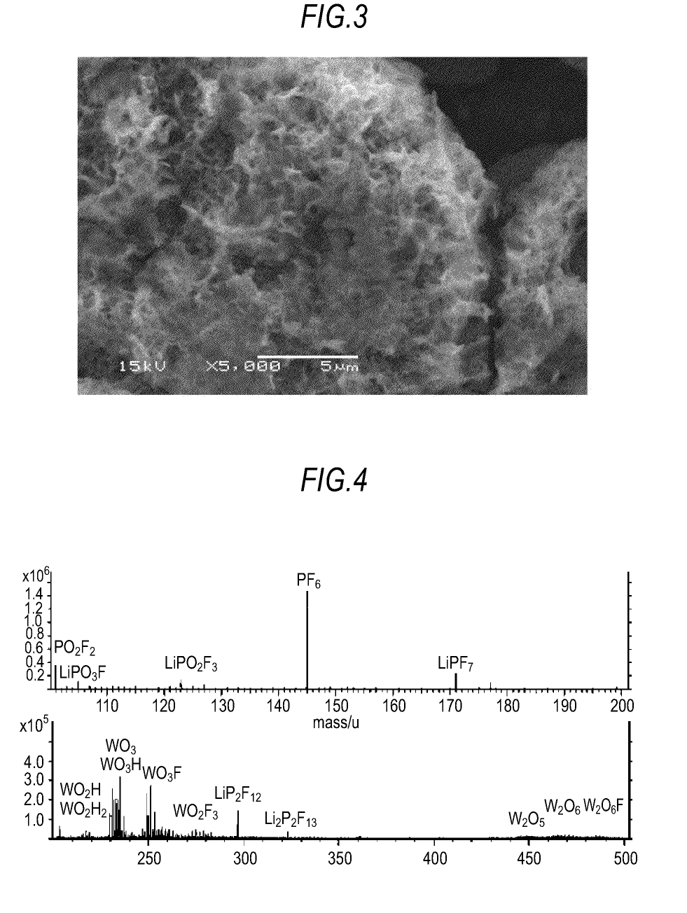

The presence or absence of a coating derived from the heteropolyacid and/or the heteropolyacid compound can be confirmed using SEM (scanning electron microscope) by disassembling the nonaqueous electrolyte battery after charge or preliminary charge and taking out the negative electrode 34. Incidentally, FIG. 3 is an SEM image of the negative electrode surface after charge and is a photograph taken by washing the nonaqueous electrolytic solution and then drying.

As a result of confirming a composition of the deposit deposited on the negative electrode collector 34A, if the polyacid and/or the polyacid compound is deposited, it can be easily assumed that the polyacid and/or the polyacid compound is similarly deposited on the negative electrode active material layer 34B, and it can be confirmed that the coating derived from the heteropolyacid and/or the heteropolyacid compound is formed. The presence or absence of the polyacid and/or the polyacid compound can be, for example, confirmed by SEM-EDX (scanning electron microscope-energy dispersive X-ray spectrometry), X-ray photoelectron spectroscopy (XPS) or time-of-flight secondary ion mass spectrometry (ToF-SIMS). In that case, the battery is disassembled, followed by washing with dimethyl carbonate. This is made for the purpose of removing a solvent component with low volatility or the like existing on the surface. It is desirable that sampling is carried out in an inert atmosphere if it is at all possible.

For example, FIG. 4 shows an example of a secondary ion spectrum by the time-of-flight secondary ion mass spectrometry (ToF-SIMS) on the negative electrode surface of the nonaqueous electrolyte battery in which the negative electrode coating derived from silicotungstic acid is formed by means of charge. It is noted from FIG. 4 that a molecule containing, as constituent elements, tungsten (W) and oxygen (O) is existent.

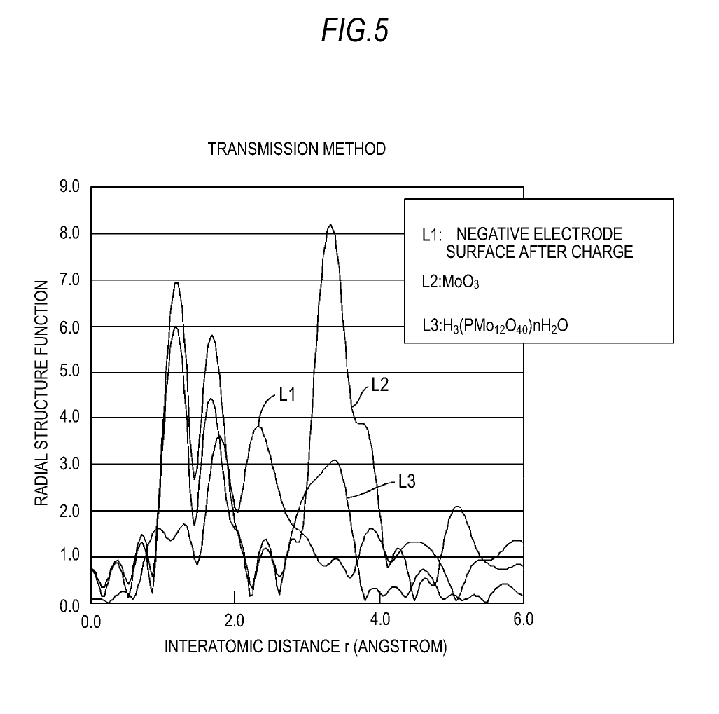

Also, FIG. 5 shows an example of a radial structure function of a W-O bond obtained by the Fourier transformation of a spectrum by the X-ray absorption fine structure (XAFS) analysis on the negative electrode surface of the nonaqueous electrolyte battery in which the negative electrode coating according to the first embodiment of the present disclosure is formed by adding silicotungstic acid to the inside of a battery system and charging the battery. Also, FIG. 5 shows an example of a radial structure function of a W-O bond of each of tungstic acid (WO₃ or WO₂) and silicotungstic acid (H₄(SiW₁₂O₄₀).26H₂O) along with the analysis results of the negative electrode coating.

It is noted from FIG. 5 that a peak L1 of a deposit on the negative electrode surface has peaks at a different position from peaks L2, L3 and L4 of silicotungstic acid (H₄(SiW₁₂O₄₀).26H₂O), tungsten dioxide (WO₂) and tungsten trioxide (WO₃), respectively and has a different structure. In tungsten trioxide (WO₃) and tungsten dioxide (WO₂), both of which are a typical tungsten oxide, and silicotungstic acid (H₄(SiW₁₂O₄₀).26H₂O) which is a starting material according to the first embodiment of the present disclosure, in view of the radical structure function, main peaks are existent in the range of from 1.0 to 2.0 angstroms, and peaks can also be confirmed in the range of from 2.0 to 4.0 angstroms.

On the other hand, in the distribution of the W-O bond distance of the polyacid composed mainly of tungstic acid deposited on each of the positive electrode and the negative electrode according to the first embodiment of the present disclosure, though the peaks are confirmed within the range of from 1.0 to 2.0 angstroms, distinct peaks equivalent to those in the peak L1 are not found in the outside of the foregoing range. That is, no peak is substantially observed in the range exceeding 3.0 angstroms. In such a situation, it is confirmed that the deposit on the negative electrode surface is amorphous.

Also, the heteropolyacid and/or the heteropolyacid compound in the electrolytic solution is electrolyzed by initial charge or preliminary charge depending upon the addition amount of the heteropolyacid and/or the heteropolyacid compound, whereby a compound derived from the heteropolyacid and/or the heteropolyacid compound is deposited on the surface of the positive electrode 33 to form a coating.

Also, in view of the fact that the electrolytic solution having the heteropolyacid and/or the heteropolyacid compound dissolved therein is impregnated in the negative electrode active material layer 34B, a compound derived from the heteropolyacid and/or the heteropolyacid compound may be deposited within the negative electrode active material layer 34B by charge or preliminary charge. According to this, the compound derived from the heteropolyacid and/or the heteropolyacid compound may exist among the negative electrode active material particles.

Also, in view of the fact that the electrolytic solution having the heteropolyacid and/or the heteropolyacid compound dissolved therein is impregnated in the positive electrode active material layer 33B, a compound derived from the heteropolyacid and/or the heteropolyacid compound may be deposited within the positive electrode active material layer 33B by charge or preliminary charge. According to this, the compound derived from the heteropolyacid and/or the heteropolyacid compound may exist among positive electrode active material particles.

### (Content)

A content of the heteropolyacid and/or the heteropolyacid compound is preferably 0.1% by mass or more and not more than 10.0% by mass, and more preferably 0.5% by mass or more and not more than 7.0% by mass relative to the total mass of the electrolytic solution. This is because when the content of the heteropolyacid and/or the heteropolyacid compound is less than 0.1% by mass, the amount of the formed coating is small, so that the effect for suppressing the decomposition of the carboxylate is not sufficiently obtained; whereas when the content of the heteropolyacid and/or the heteropolyacid compound exceeds 10.0% by mass, the amount of the formed coating is too large and becomes a resistance, thereby adversely affecting the battery characteristics.

In this nonaqueous electrolyte battery, the electrolytic solution contains a heteropolyacid and/or a heteropolyacid compound together with a chain carboxylate with a total carbon number of 4 or more. According to this, a side reaction of the electrolyte active material and the electrolytic solution at the time of charge/discharge is suppressed, so that a lowering of the high-temperature cycle characteristic or the generation of a gas at the time of high-temperature cycle can be suppressed. For example, decomposition itself of the chain carboxylate with a total carbon number of 4 or more can also be suppressed. This is because it may be considered that the coating (SEI; solid electrolyte interface coating) on the negative electrode 34, which is formed by the decomposition of the heteropolyacid and/or the heteropolyacid compound at the time of charge/discharge at the beginning of use of the battery, takes a relatively stable structure.

Furthermore, by suppressing the decomposition itself of the chain carboxylate with a total carbon number of 4 or more, the generation of a gas is suppressed, whereby an increase of the battery thickness can be largely reduced as compared with the related-art techniques. In view of the fact that there is no need to feel fear on the generation of a gas due to the decomposition itself of the chain carboxylate with a total carbon number of 4 or more, it becomes possible to utilize a large amount of the chain carboxylate with a total carbon number of 4 or more for the nonaqueous electrolyte. As a result, it also becomes possible to enhance the cycle characteristic at ordinary temperature.

Also, the inventors of the present disclosure have obtained knowledge that in a nonaqueous electrolytic solution containing a large amount of a heteropolyacid and/or a heteropolyacid compound, the mobility of the heteropolyacid and/or the heteropolyacid compound decreases so that it is not uniformly diffused over the negative electrode, whereby a good and uniform SEI is not formed. That is, the inventors of the present disclosure have found that in a nonaqueous electrolytic solution containing a large amount of a heteropolyacid and/or a heteropolyacid compound, a good and uniform SEI is not formed, so that there is a tendency that excellent effects are hardly obtained.

On the other hand, in this electrolytic solution, by containing the chain carboxylate with a total carbon number of 4 or more having a low viscosity together with the heteropolyacid and/or the heteropolyacid compound, a reduction of the mobility of the heteropolyacid and/or the heteropolyacid compound can be suppressed. According to this, even in the case of containing a large amount of the heteropolyacid and/or the heteropolyacid compound, excellent characteristics are obtainable.

### (Polymer Compound)

As the polymer compound, a compound which is gelled upon absorption of the electrolytic solution can be used. The polymer compound may be used singly or in admixture of two or more kinds thereof, or may be a copolymer of two or more kinds thereof. Specific examples thereof include polyacrylonitrile, polyvinylidene fluoride, a copolymer of polyvinylidene fluoride and polyhexafluoropropylene, polytetrafluoroethylene, polyhexafluoropropylene, polyethylene oxide, polypropylene oxide, polyphosphazene, polysiloxane, polyvinyl acetate, polyvinyl alcohol, polymethyl methacrylate, polyacrylic acid, polymethacrylic acid, a styrene-butadiene rubber, a nitrile-butadiene rubber, polystyrene and polycarbonate. These materials may be used singly or in admixture of plural kinds thereof. Of these, polyacrylonitrile, polyvinylidene fluoride, polyhexafluoropropylene or polyethylene oxide is preferable. This is because such a compound is electrochemically stable.

### (Manufacturing Method of Battery)

This nonaqueous electrolyte battery is, for example, manufactured by the following three kinds of manufacturing methods (first to third manufacturing methods).

### (First Manufacturing Method)

### (Manufacture of Positive Electrode)

First of all, the positive electrode 33 is fabricated. For example, a positive electrode material, a binder and a conductive agent are mixed to form a positive electrode mixture, which is then dispersed in an organic solvent to form a positive electrode mixture slurry in a paste form. Subsequently, the positive electrode mixture slurry is uniformly coated on the both surfaces of the positive electrode collector 33A by a doctor blade or a bar coater or the like and then dried. Finally, the coating is subjected to compression molding by a roll press or the like while heating, if desired, thereby forming the positive electrode active material layer 33B. In that case, the compression molding may be repeatedly carried out plural times.

### (Manufacture of Negative Electrode)

Next, the negative electrode 34 is fabricated. For example, a negative electrode material and a binder and optionally, a conductive agent are mixed to form a negative electrode mixture, which is then dispersed in an organic solvent to form a negative electrode mixture slurry in a paste form. Subsequently, the negative electrode mixture slurry is uniformly coated on the both surfaces of the negative electrode collector 34A by a doctor blade or a bar coater or the like and then dried. Finally, the coating is subjected to compression molding by a roll press or the like while heating, if desired, thereby forming the negative electrode active material layer 34B.

Subsequently, a precursor solution containing an electrolytic solution, a polymer compound and a solvent is prepared and coated on each of the positive electrode 33 and the negative electrode 34, and the solvent is then vaporized to form the electrolyte 36 in a gel form. The heteropolyacid and/or the heteropolyacid compound is added at the preparation of the electrolytic solution. Subsequently, the positive electrode lead 31 is installed in the positive electrode collector 33A, and the negative electrode lead 32 is also installed in the negative electrode collector 34A.

Subsequently, the positive electrode 33 and the negative electrode 34 each having the electrolyte 36 formed thereon are laminated via the separator 35, the laminate is then wound in a longitudinal direction thereof, and the protective tape 37 is allowed to adhere to an outermost peripheral part thereof, thereby fabricating the wound electrode body 30. Finally, for example, the wound electrode body 30 is interposed between the two package members 40 in a film form, and the outer edges of the package members 40 are allowed to adhere to each other by means of heat fusion or the like, thereby sealing the wound electrode body 30 therein. On that occasion, the contact film 41 is inserted between each of the positive electrode lead 31 and the negative electrode lead 32 and the package member 40. There is thus completed the nonaqueous electrolyte battery shown in FIGS. 1 and 2.

### (Second Manufacturing Method)

First of all, each of the positive electrode 33 and the negative electrode 34 is fabricated in the same manner as in the first manufacturing method. Subsequently, the positive electrode lead 31 is installed in the positive electrode 33, and the negative electrode lead 32 is also installed in the negative electrode 34. Subsequently, the positive electrode 33 and the negative electrode 34 are laminated via the separator 35 and wound, and thereafter, the protective tape 37 is allowed to adhere to an outermost peripheral part thereof, thereby fabricating a wound body which is a precursor of the wound electrode body 30.

Subsequently, the wound body is interposed between the two package members 40 in a film form, and the outer edges exclusive of one side are allowed to adhere to each other by heat fusion or the like, thereby housing the wound body in the inside of the package member 40 in a bag form. Subsequently, an electrolyte composition containing the electrolytic solution, a monomer as a raw material of a polymer compound, a polymerization initiator and optionally, other material such as a polymerization inhibitor is prepared and injected into the inside of the package member 40 in a bag form, and thereafter, an opening of the package member 40 is hermetically sealed by means of heat fusion or the like. The heteropolyacid and/or the heteropolyacid compound is added at the preparation of the electrolytic solution. Finally, the monomer is heat polymerized to prepare a polymer compound, thereby forming the electrolyte 36 in a gel form. There is thus completed the nonaqueous electrolyte battery shown in FIGS. 1 and 2.

### (Third Manufacturing Method)

In a third manufacturing method, first of all, a wound body is formed and housed in the inside of the package member 40 in a bag form in the same manner as in the foregoing second manufacturing method, except for using the separator 35 having a polymer compound coated on the both surfaces thereof.

Examples of the polymer compound which is coated on this separator 35 include polymers composed of, as a component, vinylidene fluoride, namely a homopolymer, a copolymer or a multi-component copolymer, or the like. Specific examples thereof include polyvinylidene fluoride; a binary copolymer composed of, as components, vinylidene fluoride and hexafluoropropylene; and a ternary copolymer composed of, as components, vinylidene fluoride, hexafluoropropylene and chlorotrifluoroethylene.

Incidentally, the polymer compound may contain one or two or more kinds of other polymer compounds together with the foregoing polymer composed of, as a component, vinylidene fluoride. Subsequently, the electrolytic solution is prepared and injected in the inside of the package member 40, and thereafter, an opening of the package member 40 is hermetically sealed by means of heat fusion or the like. The heteropolyacid and/or the heteropolyacid compound is added at the preparation of the electrolytic solution. Finally, the separator 35 is brought into intimate contact with each of the positive electrode 33 and the negative electrode 34 via the polymer compound upon heating while adding a weight to the package member 40. According to this, the electrolytic solution is impregnated in the polymer compound, and the polymer compound is gelled to form the electrolyte 36. There is thus completed the nonaqueous electrolyte battery shown in FIGS. 1 and 2.

This nonaqueous electrolyte battery is, for example, a nonaqueous electrolyte secondary battery capable of undergoing charge and discharge. For example, when charged, a lithium ion is deintercalated from the positive electrode 33 and intercalated in the negative electrode 34 via the electrolyte 36. When discharged, the lithium ion is deintercalated from the negative electrode 34 and intercalated in the positive electrode 33 via the electrolyte 36. Alternatively, for example, when charged, the lithium ion in the electrolyte 36 receives an electron and is deposited as metallic lithium on the negative electrode 34. When discharged, the metallic lithium of the negative electrode 34 deintercalates an electron and is dissolved as a lithium ion in the electrolyte 36. Alternatively, for example, when charged, the lithium ion is deintercalated from the positive electrode 33 and intercalated in the negative electrode 34 via the electrolyte 36, and the metallic lithium is deposited on the way of charge. When discharged, the metallic lithium deposited in the negative electrode 34 deintercalates an electron and is dissolved as a lithium ion in the electrolyte 36; the lithium ion intercalated in the negative electrode 34 is deintercalated on the way of discharge; and these lithium ions are intercalated in the positive electrode 33 via the electrolyte 36.

### MODIFICATION EXAMPLES

While in the foregoing configuration example of the nonaqueous electrolyte battery, an example in which the heteropolyacid and/or the heteropolyacid compound is previously added to the electrolytic solution has been described, the heteropolyacid and/or the heteropolyacid compound may be previously added to other battery constituent element than the electrolytic solution.

In the following first to third modification examples, configuration examples of a nonaqueous electrolyte battery in which the heteropolyacid and/or the heteropolyacid compound is previously added to other battery constituent element than the electrolytic solution are described. Incidentally, in the following, descriptions are made centering on points which are different from those of the foregoing configuration examples of a nonaqueous electrolyte battery (an example in which the heteropolyacid and/or the heteropolyacid compound is previously added to the electrolytic solution), and descriptions on the same points as those in the foregoing configuration examples of a nonaqueous electrolyte battery are properly omitted.

### First Modification Example

### Example of Adding a Heteropolyacid and/or a Heteropolyacid Compound to a Positive Electrode Active Material Layer

A first modification example is the same as the foregoing configuration example of a nonaqueous electrolyte battery, except that the heteropolyacid and/or the heteropolyacid compound is not previously added to the electrolytic solution but added to the positive electrode active material layer 33B.

### (Manufacturing Method of Positive Electrode 33)

In the first modification example, the positive electrode 33 is fabricated in the following manner. First of all, a positive electrode material, a binder and a conductive agent are mixed. Also, a heteropolyacid and/or a heteropolyacid compound is dissolved in an organic solvent such as N-methyl-2-pyrrolidone to prepare a solution. Subsequently, this solution is mixed with the foregoing mixture of a positive electrode material, a binder and a conductive agent to prepare a positive electrode mixture, and this positive electrode mixture is then dispersed in an organic solvent such as N-methyl-2-pyrrolidone to form a positive electrode mixture slurry. Subsequently, the positive electrode mixture slurry is uniformly coated on the both surfaces of the positive electrode collector 33A by a doctor blade or a bar coater or the like and then dried. Finally, the coating is subjected to compression molding by a roll press or the like while heating, if desired, thereby forming the positive electrode active material layer 33B.

### (Positive Electrode Active Material Layer 33B)

In the first modification example, the positive electrode active material layer 33B contains, as a positive electrode active material, one or two or more kinds of positive electrode materials capable of intercalating and deintercalating lithium and a heteropolyacid and/or a heteropolyacid compound before charge/discharge. Incidentally, the positive electrode active material layer 33B may also contain other materials such as a binder and a conductive agent, if desired.

(Behavior of Heteropolyacid and/or Heteropolyacid Compound by Charge)

The electrolytic solution is impregnated in the positive electrode active material layer 33B. According to this, the heteropolyacid and/or the heteropolyacid compound contained in the positive electrode active material layer 33B elutes into the electrolytic solution. Then, a coating derived from the heteropolyacid and/or the heteropolyacid compound having eluted into the electrolytic solution is formed on the negative electrode 34 by initial charge or preliminary charge.

That is, the heteropolyacid and/or the heteropolyacid compound having eluted into the electrolytic solution is electrolyzed by initial charge or preliminary charge, whereby a compound derived from the heteropolyacid and/or the heteropolyacid compound is deposited on the surface of the negative electrode 34 to form a coating.

Also, the heteropolyacid and/or the heteropolyacid compound having eluted into the electrolytic solution is electrolyzed by initial charge or preliminary charge depending upon the addition amount of the heteropolyacid and/or the heteropolyacid compound, whereby a compound derived from the heteropolyacid and/or the heteropolyacid compound is deposited on the surface of the positive electrode 33 to form a coating.

Also, in view of the fact that the electrolytic solution having the heteropolyacid and/or the heteropolyacid compound eluted thereinto is impregnated in the negative electrode active material layer 34B, a compound derived from the heteropolyacid and/or the heteropolyacid compound may be deposited within the negative electrode active material layer 34B by charge or preliminary charge. According to this, a compound derived from the heteropolyacid and/or the heteropolyacid compound may exist among negative electrode active material particles.

Also, in view of the fact that the electrolytic solution having the heteropolyacid and/or the heteropolyacid compound eluted thereinto is impregnated in the positive electrode active material layer 33B, a compound derived from the heteropolyacid and/or the heteropolyacid compound may be deposited within the positive electrode active material layer 33B by charge or preliminary charge. According to this, a compound derived from the heteropolyacid and/or the heteropolyacid compound may exist among positive electrode active material particles.

### Second Modification Example

### Example of Previously Adding a Heteropolyacid and/or a Heteropolyacid Compound to a Negative Electrode Active Material Layer

A second modification example is the same as the foregoing configuration example of a nonaqueous electrolyte battery, except that the heteropolyacid and/or the heteropolyacid compound is not previously added to the electrolytic solution but added to the negative electrode active material layer 34B.

### (Manufacturing Method of Negative Electrode 34)

In the second modification example, the negative electrode 34 is fabricated in the following manner. First of all, a negative electrode material, a binder and optionally, a conductive agent are mixed. Also, a heteropolyacid and/or a heteropolyacid compound is dissolved to prepare a solution. Subsequently, this solution is mixed with the foregoing mixture to prepare a negative electrode mixture, which is then dispersed in an organic solvent such as N-methyl-2-pyrrolidone to form a negative electrode mixture slurry in a paste form. Subsequently, the negative electrode mixture slurry is uniformly coated on the both surfaces of the negative electrode collector 34A by a doctor blade or a bar coater or the like and then dried. Finally, the coating is subjected to compression molding by a roll press or the like while heating, if desired, thereby forming the negative electrode active material layer 34B.

### (Negative Electrode Active Material Layer 34B)

In the second modification example, the negative electrode active material layer 34B contains, as a negative electrode active material, one or two or more kinds of negative electrode materials capable of intercalating and deintercalating lithium and a heteropolyacid and/or a heteropolyacid compound before charge/discharge. Incidentally, the negative electrode active material layer 34B may also contain other materials such as a binder and a conductive agent, if desired.

(Behavior of Heteropolyacid and/or Heteropolyacid Compound by Charge)

The electrolytic solution is impregnated in the negative electrode active material layer 34B. According to this, the heteropolyacid and/or the heteropolyacid compound contained in the negative electrode active material layer 34B elutes into the electrolytic solution. Then, a coating derived from the heteropolyacid and/or the heteropolyacid compound having eluted into the electrolytic solution is formed on the negative electrode 34 by initial charge or preliminary charge.

That is, the heteropolyacid and/or the heteropolyacid compound having eluted into the electrolytic solution is electrolyzed by initial charge or preliminary charge, whereby a compound derived from the heteropolyacid and/or the heteropolyacid compound is deposited on the surface of the negative electrode 34 to form a coating.

Also, the heteropolyacid and/or the heteropolyacid compound having eluted into the electrolytic solution is electrolyzed by initial charge or preliminary charge depending upon the addition amount of the heteropolyacid and/or the heteropolyacid compound, whereby a compound derived from the heteropolyacid and/or the heteropolyacid compound is deposited on the surface of the positive electrode 33 to form a coating.

Also, in view of the fact that the electrolytic solution having the heteropolyacid and/or the heteropolyacid compound eluted thereinto is impregnated in the negative electrode active material layer 34B, a compound derived from the heteropolyacid and/or the heteropolyacid compound may be deposited within the negative electrode active material layer 34B by charge or preliminary charge. According to this, a compound derived from the heteropolyacid and/or the heteropolyacid compound may exist among negative electrode active material particles.

Also, in view of the fact that the electrolytic solution having the heteropolyacid and/or the heteropolyacid compound eluted thereinto is impregnated in the positive electrode active material layer 33B, a compound derived from the heteropolyacid and/or the heteropolyacid compound may be deposited within the positive electrode active material layer 33B by charge or preliminary charge. According to this, a compound derived from the heteropolyacid and/or the heteropolyacid compound may exist among positive electrode active material particles.

### Third Modification Example

A third modification example is the same as the foregoing configuration example of a nonaqueous electrolyte battery, except that the heteropolyacid and/or the heteropolyacid compound is not previously added to the electrolytic solution, but the heteropolyacid and/or the heteropolyacid compound is previously added to the separator 35.

In the third modification example, the heteropolyacid and/or the heteropolyacid compound is previously added to the separator 35. For example, the heteropolyacid and/or the heteropolyacid compound is previously added to the separator 35 in the following manner.

The separator 35 is dipped in and impregnated with a solution obtained by dissolving the heteropolyacid and/or the heteropolyacid compound in a polar organic solvent such as dimethyl carbonate, followed by drying in a vacuum atmosphere. According to this, the heteropolyacid and/or the heteropolyacid compound is deposited on the surface or within pores of the separator 35.

(Behavior of Heteropolyacid and/or Heteropolyacid Compound by Charge)

The electrolytic solution is impregnated in the separator 35. According to this, the heteropolyacid and/or the heteropolyacid compound added to the separator 35 elutes into the electrolytic solution. Then, a coating derived from the heteropolyacid and/or the heteropolyacid compound having eluted into the electrolytic solution is formed on the negative electrode 34 by initial charge or preliminary charge.

That is, the heteropolyacid and/or the heteropolyacid compound having eluted into the electrolytic solution is electrolyzed by initial charge or preliminary charge, whereby a compound derived from the heteropolyacid and/or the heteropolyacid compound is deposited on the surface of the negative electrode 34 to form a coating.

Also, the heteropolyacid and/or the heteropolyacid compound having eluted into the electrolytic solution is electrolyzed by initial charge or preliminary charge depending upon the addition amount of the heteropolyacid and/or the heteropolyacid compound, whereby a compound derived from the heteropolyacid and/or the heteropolyacid compound is deposited on the surface of the positive electrode 33 to form a coating.

Also, in view of the fact that the electrolytic solution having the heteropolyacid and/or the heteropolyacid compound eluted thereinto is impregnated in the negative electrode active material layer 34B, a compound derived from the heteropolyacid and/or the heteropolyacid compound may be deposited within the negative electrode active material layer 34B by charge or preliminary charge. According to this, a compound derived from the heteropolyacid and/or the heteropolyacid compound may exist among negative electrode active material particles.

Also, in view of the fact that the electrolytic solution having the heteropolyacid and/or the heteropolyacid compound eluted thereinto is impregnated in the positive electrode active material layer 33B, a compound derived from the heteropolyacid and/or the heteropolyacid compound may be deposited within the positive electrode active material layer 33B by charge or preliminary charge. According to this, a compound derived from the heteropolyacid and/or the heteropolyacid compound may exist among positive electrode active material particles.

### 2. Second Embodiment

A nonaqueous electrolyte battery according a second embodiment of the present disclosure is described. The nonaqueous electrolyte battery according to the second embodiment of the present disclosure is that the same as the nonaqueous electrolyte battery according to the first embodiment of the present disclosure, except that the electrolytic solution is used as it is in place of one (electrolyte 36) having the electrolytic solution held by the polymer compound. In consequence, the configuration is hereunder described in detail centering on points which are different from those of the first embodiment of the present disclosure.

### (Configuration of Nonaqueous Electrolyte Battery)

In the nonaqueous electrolyte battery according to the second embodiment of the present disclosure, an electrolytic solution is used in place of the electrolyte 36 in a gel form. In consequence, the wound electrode body 30 has a configuration in which the electrolyte 36 is omitted, and the electrolytic solution is impregnated in the separator 35.

### (Manufacturing Method of Nonaqueous Electrolyte Battery)

This nonaqueous electrolyte battery is, for example, manufactured in the following manner.

First of all, for example, a positive electrode active material, a binder and a conductive agent are mixed to prepare a positive electrode mixture, which is then dispersed in a solvent such as N-methyl-2-pyrrolidone to prepare a positive electrode mixture slurry. Subsequently, this positive electrode mixture slurry is coated on the both surfaces of the positive electrode collector 33A and dried, and the resultant is then compression molded to form the positive electrode active material layer 33B. There is thus fabricated the positive electrode 33. Subsequently, for example, the positive electrode lead 31 is joined with the positive electrode collector 33A by means of, for example, ultrasonic welding, spot welding or the like.

Also, for example, a negative electrode material and a binder are mixed to prepare a negative electrode mixture, which is then dispersed in a solvent such as N-methyl-2-pyrrolidone to prepare a negative electrode mixture slurry. Subsequently, this negative electrode mixture slurry is coated on the both surfaces of the negative electrode collector 34A and dried, and the resultant is then compression molded to form the negative electrode active material layer 34B. There is thus fabricated the negative electrode 34. Subsequently, for example, the negative electrode lead 32 is joined with the negative electrode collector 34A by means of, for example, ultrasonic welding, spot welding or the like.

Subsequently, the positive electrode 33 and the negative electrode 34 are wound via the separator 35; the resultant is interposed into the package member 40; and thereafter, the electrolytic solution is injected into the inside of the package member 40, followed by hermetically sealing the package member 40. There is thus obtained the nonaqueous electrolyte battery shown in FIGS. 1 and 2.

### 3. Third Embodiment

### Configuration of Nonaqueous Electrolyte Battery

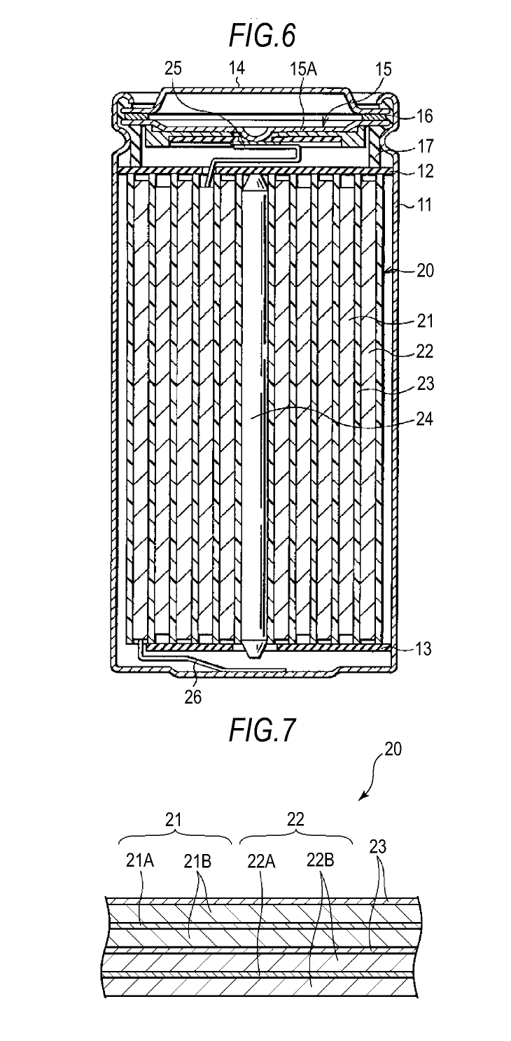

Next, a configuration of a nonaqueous electrolyte battery according to a third embodiment of the present disclosure is described while referring to FIGS. 6 to 7. FIG. 6 shows an example of a configuration of a nonaqueous electrolyte battery according to the third embodiment of the present disclosure. This nonaqueous electrolyte battery is of a so-called cylindrical type and has a wound electrode body having a strip-shaped positive electrode 21 and a strip-shaped negative electrode 22 wound via a separator 23 in the inside of a substantially hollow columnar battery can 11 that is a cylindrical can as a package member. The separator 23 is impregnated with an electrolytic solution that is a liquid electrolyte. The battery can 11 is constituted of, for example, iron (Fe) plated with nickel (Ni), and one end thereof is closed, with the other end being opened. In the inside of the battery can 11, a pair of insulating plates 12 and 13 is respectively disposed vertical to the winding peripheral face so as to interpose the wound electrode body 20 therebetween.

In the open end of the battery can 11, a battery lid 14 is installed by caulking with a safety valve mechanism 15 and a positive temperature coefficient device (PTC device) 16 provided in the inside of this battery lid 14 via a gasket 17, and the inside of the battery can 11 is hermetically sealed. The battery lid 14 is, for example, constituted of the same material as that in the battery can 11. The safety valve mechanism 15 is electrically connected to the battery lid 14 via the positive temperature coefficient device 16. In this safety valve mechanism 15, when the internal pressure of the battery reaches a fixed value or more due to an internal short circuit or heating from the outside or the like, a disc plate 15A is reversed, whereby electrical connection between the battery lid 14 and the wound electrode body 20 is disconnected. When the temperature is elevated, the positive temperature coefficient device 16 controls the current by an increase of the resistance value, thereby preventing abnormal heat generation due to a large current. The gasket 17 is, for example, constituted of an insulating material, and asphalt is coated on the surface thereof.

For example, the wound electrode body 20 is wound centering on a center pin 24. In the wound electrode body 20, a positive electrode lead 25 made of aluminum (Al) or the like is connected to the positive electrode 21; and a negative electrode lead 26 made of nickel (Ni) or the like is connected to the negative electrode 22. The positive electrode lead 25 is electrically connected to the battery lid 14 by means of welding to the safety valve mechanism 15; and the negative electrode lead 26 is electrically connected to the battery can 11 by means of welding.

FIG. 7 is a sectional view showing enlargedly a part of the wound electrode body 20 shown in FIG. 6. The wound electrode body 20 is one in which the positive electrode 21 and the negative electrode 22 are laminated via the separator 23 and wound.

The positive electrode 21 has, for example, a positive electrode collector 21A and a positive electrode active material layer 21B provided on the both surfaces of this positive electrode collector 21A. The negative electrode 22 has, for example, a negative electrode collector 22A and a negative electrode active material layer 22B provided on the both surfaces of this negative electrode collector 22A. Configurations of the positive electrode collector 21A, the positive electrode active material layer 21B, the negative electrode collector 22A, the negative electrode active material layer 22B, the separator 23 and the electrolytic solution are the same as those in the positive electrode collector 33A, the positive electrode active material layer 33B, the negative electrode collector 34A, the negative electrode active material layer 34B, the separator 35 and the electrolytic solution, respectively in the foregoing first embodiment of the present disclosure.

### (Manufacturing Method of Nonaqueous Electrolyte Battery)

The foregoing nonaqueous electrolyte battery can be manufactured in the following manner.

The positive electrode 21 is fabricated in the same manner as in the positive electrode 33 in the first embodiment of the present disclosure. The negative electrode 22 is fabricated in the same manner as in the negative electrode 34 in the first embodiment of the present disclosure.

Next, the positive electrode lead 25 is installed in the positive electrode collector 21A by means of welding or the like, and the negative electrode lead 26 is also installed in the negative electrode collector 22A by means of welding or the like. Thereafter, the positive electrode 21 and the negative electrode 22 are wound via the separator 23; a tip end of the positive electrode lead 25 is welded to the safety valve mechanism 15; and a tip end of the negative electrode lead 26 is also welded to the battery can 11. Then, the wound positive electrode 21 and negative electrode 22 are interposed between a pair of the insulating plates 12 and 13 and housed in the inside of the battery can 11. After housing the positive electrode 21 and the negative electrode 22 in the inside of the battery can 11, the electrolytic solution is injected into the inside of the battery can 11 and impregnated in the separator 23. Thereafter, the battery lid 14, the safety valve mechanism 15 and the positive temperature coefficient device 16 are fixed to the open end of the battery can 11 upon being caulked via the gasket 17. There is thus completed the nonaqueous electrolyte battery shown in FIG. 6.

### 4. Fourth Embodiment

### Configuration of Nonaqueous Electrolyte Battery

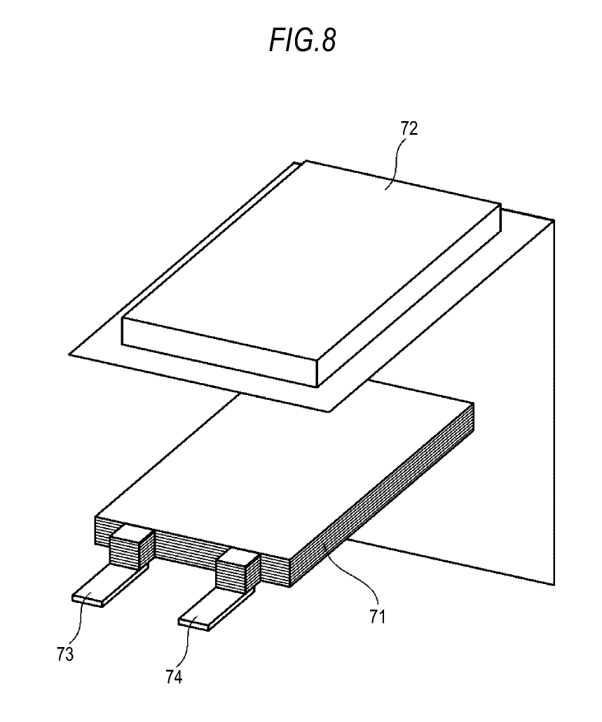

FIG. 8 is an exploded perspective view showing an example of a configuration of a nonaqueous electrolyte battery according to a fourth embodiment of the present disclosure. As shown in FIG. 8, this nonaqueous electrolyte battery is one in which a battery device 71 having a positive electrode lead 73 and a negative electrode lead 74 installed therein is housed in the inside of a package member 72 in a film form and is able to realize downsizing, weight reduction and thinning.

Each of the positive electrode lead 73 and the negative electrode lead 74 is, for example, led out from the inside of the package member 72 toward the outside in the same direction.

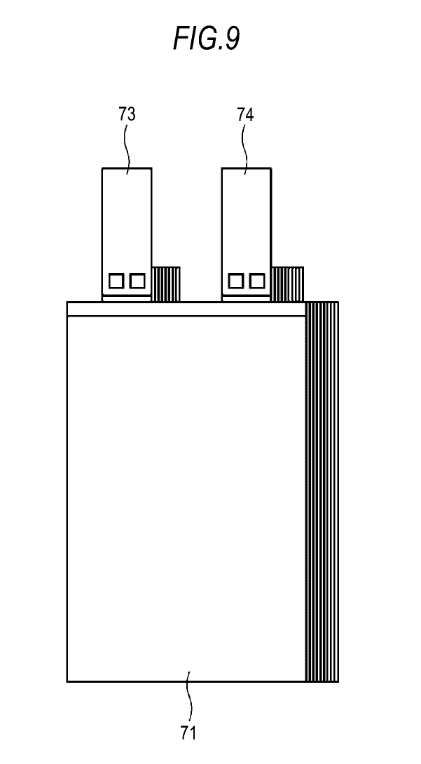

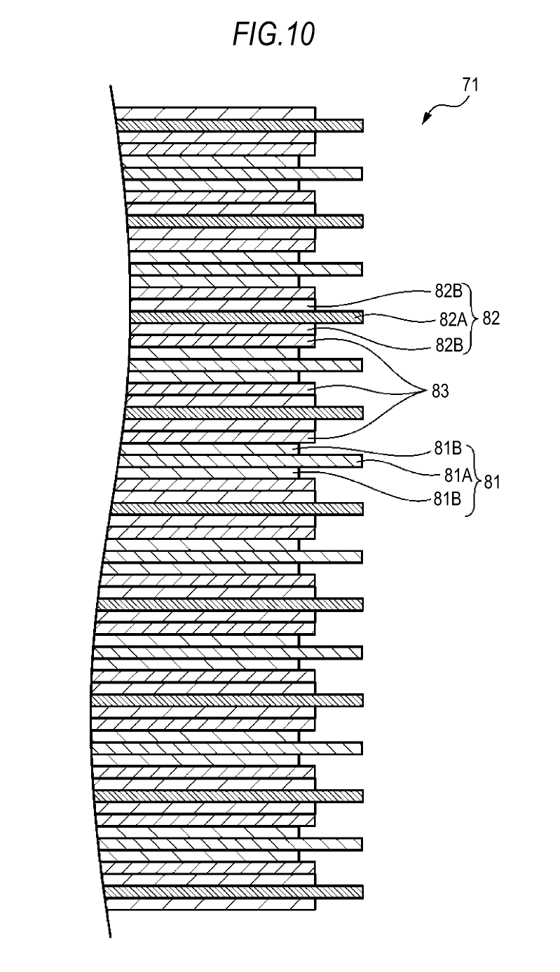

FIG. 9 is a perspective view showing an example of an appearance of the battery device 71. FIG. 10 is a sectional view showing an example of a configuration of the battery device 71. As shown in FIGS. 9 and 10, this battery device 71 is a laminated electrode body in which a positive electrode 81 and a negative electrode 82 are laminated via a separator 83, and the battery device 71 is impregnated with the electrolytic solution.

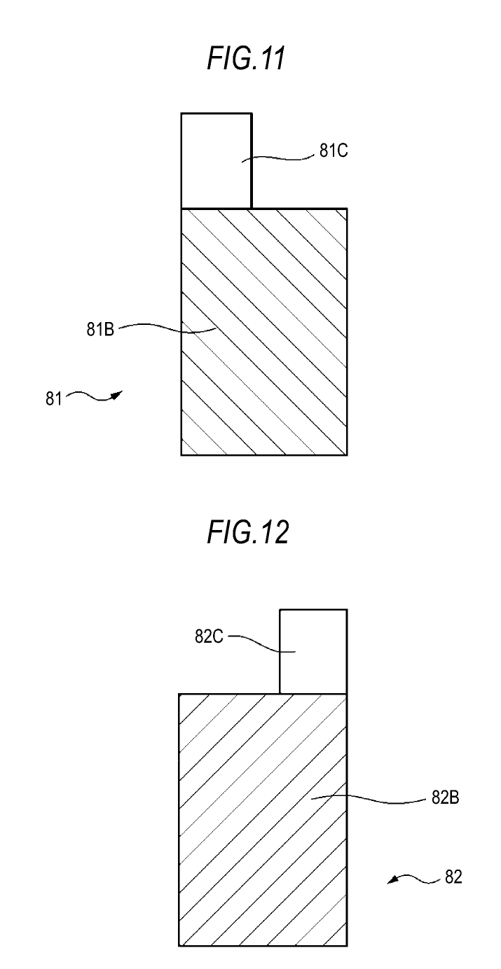

For example, the positive electrode 81 has a structure in which a positive electrode active material layer 81B is provided on the both surfaces of a positive electrode collector 81A having a pair of surfaces. As shown in FIG. 11, the positive electrode 81 has a rectangular electrode portion and a collector-exposed portion 81C extending from one side of the electrode portion. This collector-exposed portion 81C is not provided with the positive electrode active material layer 81B and is in a state where the positive electrode collector 81A is exposed. The collector-exposed portion 81C is electrically connected to the positive electrode lead 73. Incidentally, while illustration is omitted, a region where the positive electrode active material layer 81B is existent on only one surface of the positive electrode collector 81A may be provided.

For example, the negative electrode 82 has a structure in which a negative electrode active material layer 82B is provided on the both surfaces of a negative electrode collector 82A having a pair of surfaces. As shown in FIG. 12, the negative electrode 82 has a rectangular electrode portion and a collector-exposed portion 82C extending from one side of the electrode portion. This collector-exposed portion 82C is not provided with the negative electrode active material layer 82B and is in a state where the negative electrode collector 82A is exposed. The collector-exposed portion 82C is electrically connected to the negative electrode lead 74. Incidentally, while illustration is omitted, a region where the negative electrode active material layer 82B is existent on only one surface of the negative electrode collector 82A may be provided.

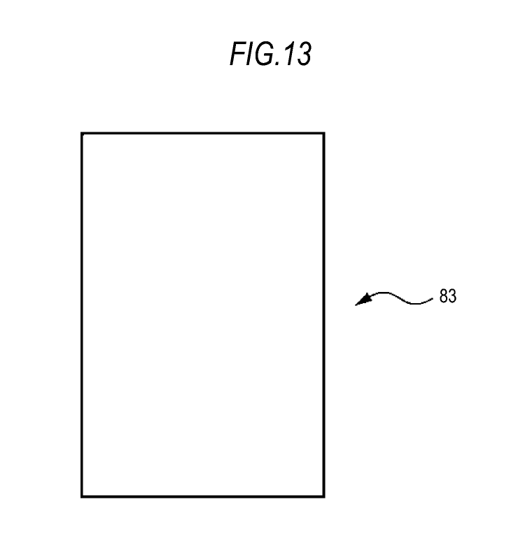

As shown in FIG. 13, the separator 83 has a shape such as a rectangular shape.

Materials constituting the positive electrode collector 81A, the positive electrode active material layer 81B, the negative electrode collector 82A, the negative electrode active material layer 82B, the separator 83 and the electrolytic solution are the same as those in the positive electrode collector 21A, the positive electrode active material layer 21B, the negative electrode collector 22A, the negative electrode active material layer 22B, the separator and the electrolytic solution, respectively in the foregoing first embodiment of the present disclosure.

### (Manufacturing Method of Nonaqueous Electrolyte Battery)

The thus configured nonaqueous electrolyte battery can be, for example, manufactured in the following manner.

### (Fabrication of Positive Electrode)

The positive electrode 81 is fabricated in the following manner. First of all, for example, a positive electrode material, a binder and a conductive agent are mixed to prepare a positive electrode mixture, and this positive electrode mixture is dispersed in an organic solvent such as N-methylpyrrolidone to prepare a positive electrode mixture slurry in a paste form. Subsequently, this positive electrode mixture slurry is coated on the both surfaces of the positive electrode collector 81A and dried, followed by pressing to form the positive electrode active material layer 81B. Thereafter, the resultant is cut into the shape shown in FIG. 11, or the like, thereby obtaining the positive electrode 81.

### (Fabrication of Negative Electrode)

The negative electrode 82 is fabricated in the following manner. First of all, for example, a negative electrode material, a binder and a conductive agent are mixed to prepare a negative electrode mixture, and this negative electrode mixture is dispersed in an organic solvent such as N-methylpyrrolidone to prepare a negative electrode mixture slurry in a paste form. Subsequently, this negative electrode mixture slurry is coated on the both surfaces of the negative electrode collector 82A and dried, followed by pressing to form the negative electrode active material layer 82B. Thereafter, the resultant is cut into the shape shown in FIG. 12, or the like, thereby obtaining the negative electrode 82.

### (Fabrication of Battery Device)

The battery device 71 is fabricated in the following manner. First of all, a polypropylene-made microporous film or the like is cut into the shape shown in FIG. 13, thereby fabricating the separator 83. Subsequently, a plural number of the thus obtained negative electrodes 82, positive electrodes 81 and separators 83 are, for example, laminated in the order of the negative electrode 82, the separator 83, the positive electrode 81, . . . , the positive electrode 81, the separator 83 and the negative electrode 82, thereby fabricating the battery device 71 as shown in FIG. 10.

Subsequently, the collector-exposed portion 81C of the positive electrode 81 is welded to the positive electrode lead 73. Similarly, the collector-exposed portion 82C of the negative electrode 82 is welded to the negative electrode lead 74. Subsequently, after impregnating the electrolytic solution in the battery device 71, the battery device 71 is interposed between the package members 72, and the outer edges of the package members 72 are allowed to adhere to each other by means of heat fusion or the like, thereby sealing the battery device 71 therein. On that occasion, each of the positive electrode lead 73 and the negative electrode lead 74 is disposed so as to come out from the package member 72 via the heat-fused part, thereby forming positive and negative electrode terminals. There is thus obtained the desired nonaqueous electrolyte battery.

### 5. Fifth Embodiment

Next, a fifth embodiment of the present disclosure is described. A nonaqueous electrolyte battery according to this fifth embodiment of the present disclosure is one using an electrolyte layer in a gel form in place of the electrolytic solution in the nonaqueous electrolyte battery according to the fourth embodiment of the present disclosure. Incidentally, the same portions as those in the foregoing fourth embodiment of the present disclosure are given the same symbols, and their descriptions are omitted.

### (Configuration of Nonaqueous Electrolyte Battery)

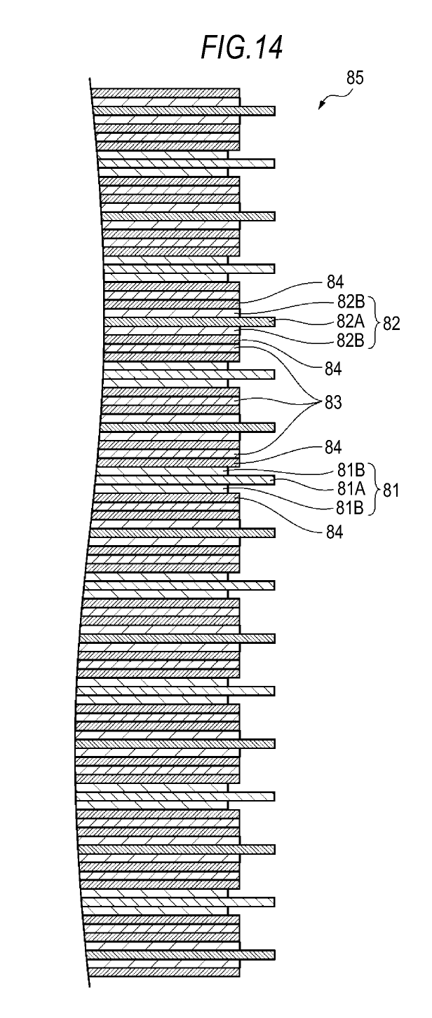

FIG. 14 is a sectional view showing an example of a configuration of a battery device to be used for the nonaqueous electrolyte secondary battery according to the fifth embodiment of the present disclosure. A battery device 85 is one in which the positive electrode 81 and the negative electrode 82 are laminated via the separator 83 and an electrolyte layer 84.

The electrolyte layer 84 contains an electrolytic solution and a polymer compound serving as a holding material capable of holding this electrolytic solution therein and takes a so-called gel form. The electrolyte layer 84 in a gel form is preferable because not only a high ion conductivity is obtainable, but liquid leakage of the battery can be prevented from occurring. A constitution of the polymer compound is the same as that in the nonaqueous electrolyte battery according to the first embodiment of the present disclosure.

### (Manufacturing Method of Nonaqueous Electrolyte Battery)

The thus configured nonaqueous electrolyte battery can be, for example, manufactured in the following manner.

First of all, a precursor solution containing an electrolytic solution, a polymer compound and a mixed solvent is coated on each of the positive electrode 81 and the negative electrode 82, and the mixed solvent is then vaporized to form the electrolyte layer 84. The nonaqueous electrolyte battery can be obtained by following the same subsequent steps as those in the foregoing fourth embodiment of the present disclosure, except that the positive electrode 81 and the negative electrode 82 each having the electrolyte layer 84 formed thereon are used.

### EXAMPLES

The technologies of the present disclosure are specifically described below with reference to the following Examples, but it should not be construed that the technologies of the present disclosure are limited only to these Examples.

The heteropolyacids and/or heteropolyacid compounds used in the following Examples and Comparative Examples are as follows.

Phosphomolybdic acid 30-hydrate: H₃[PMo₁₂O₄₀]30H₂O (2)

Silicomolybdic acid 30-hydrate: H₄[SiMo₁₂O₄₀].30H₂O (3)

Phosphotungstic acid 30-hydrate: H₃[PW₁₂O₄₀].30H₂O (4)

Silicotungstic acid 30-hydrate: H₄[SiW₁₂O₄₀].30H₂O (5)

Phosphomolybdic acid heptahydrate: H₃[PMo₁₂O₄₀].7H₂O (6)

Silicomolybdic acid heptahydrate: H₄[SiMo₁₂O₄₀].7H₂O (7)

Phosphotungstic acid heptahydrate: H₃[PW₁₂O₄₀].7H₂O (8)

Silicotungstic acid heptahydrate: H₄[SiW₁₂O₄₀].7H₂O (9)

Lithium silicotungstate: Li₄[SiW₁₂O₄₀] (10)

### Example 1-1

First of all, 94 parts by mass of lithium nickel complex oxide (LiNiO₂) as a positive electrode active material, 3 parts by mass of graphite as a conductive agent and 3 parts by mass of polyvinylidene fluoride (PVdF) as a binder were uniformly mixed, to which was then added N-methylpyrrolidone to obtain a positive electrode mixture coating solution. Subsequently, the obtained positive electrode mixture coating solution was uniformly coated on the both surfaces of an aluminum foil having a thickness of 10 μm and then dried to form a positive electrode mixture layer having a thickness per one surface of 30 μm (volume density of the mixture: 3.40 g/cc). This was cut into a shape of 50 mm in width and 300 mm in length, thereby fabricating a positive electrode.

Subsequently, 97 parts by mass of MCMB based graphite as a negative electrode active material and 3 parts by mass of PVdF as a binder were uniformly mixed, to which was then added N-methylpyrrolidone to obtain a negative electrode mixture coating solution. Subsequently, the obtained negative electrode mixture coating solution was uniformly coated on the both surfaces of a copper foil having a thickness of 10 μm serving as a negative electrode collector, and after drying, the resultant was crushed at 200 MPa to form a negative electrode mixture layer having a thickness per one surface of 30 μm. This was cut into a shape of 50 mm in width and 300 mm in length, thereby fabricating a negative electrode (volume density of the mixture: 1.80 g/cc).

A mixture containing a mixed solvent obtained by mixing ethylene carbonate (EC), diethyl carbonate (DEC) and ethyl butyrate (EB) as a solvent; lithium hexafluorophosphate (LiPF₆) as an electrolyte salt; and phosphomolybdic acid 30-hydrate (formula (2)) as a heteropolyacid compound represented by the formula (I) was used as an electrolytic solution. On that occasion, a composition of the mixed solvent was set to be EC/DEC/EB of 40/40/20 in terms of a mass ratio; a concentration of LiPF₆ in the electrolytic solution was set to be 1 mole/kg; and a content of the phosphomolybdic acid 30-hydrate (formula (2)) was set to be 0.1% by mass. The “% by mass” as referred to herein is a value in the case of defining the electrolytic solution as 100% by mass, and the meaning of the “% by mass” is hereinafter also the same. Also, the mass of the phosphomolybdic acid 30-hydrate is one from which a mass of bound water is removed.

As a separator, one prepared by coating polyvinylidene fluoride in a thickness of 2 μm on each surface of a microporous polyethylene film having a thickness of 7 μm was used. The positive electrode and the negative electrode were laminated via the separator and wound up, and the wound body was put into a bag made of an aluminum laminated film. 2 g of the electrolytic solution was injected into this bag, and the bag was then heat fused to fabricate a laminated film type battery.

### Example 1-2

A laminated film type battery of Example 1-2 was fabricated in the same manner as in Example 1-1, except that the content of the phosphomolybdic acid 30-hydrate (formula (2)) was set to be 0.5% by mass.

### Example 1-3

A laminated film type battery of Example 1-3 was fabricated in the same manner as in Example 1-1, except that the content of the phosphomolybdic acid 30-hydrate (formula (2)) was set to be 4.0% by mass.

### Example 1-4

A laminated film type battery of Example 1-4 was fabricated in the same manner as in Example 1-1, except that the content of the phosphomolybdic acid 30-hydrate (formula (2)) was set to be 7.0% by mass.

### Example 1-5

A laminated film type battery of Example 1-5 was fabricated in the same manner as in Example 1-1, except that the content of the phosphomolybdic acid 30-hydrate (formula (2)) was set to be 10.0% by mass.

### Examples 1-6 to 1-10

Laminated film type batteries of Examples 1-6 to 1-10 were fabricated in the same manners as in Examples 1-1 to 1-5, respectively, except that silicomolybdic acid 30-hydrate (formula (3)) was used in place of the phosphomolybdic acid 30-hydrate (formula (2)).

### Examples 1-11 to 1-15

Laminated film type batteries of Examples 1-11 to 1-15 were fabricated in the same manners as in Examples 1-1 to 1-5, respectively, except that phosphotungstic acid 30-hydrate (formula (4)) was used in place of the phosphomolybdic acid 30-hydrate (formula (2)).

### Examples 1-16 to 1-20

Laminated film type batteries of Examples 1-16 to 1-20 were fabricated in the same manners as in Examples 1-1 to 1-5, respectively, except that silicotungstic acid 30-hydrate (formula (5)) was used in place of the phosphomolybdic acid 30-hydrate (formula (2)).

### Examples 1-21 to 1-25

Laminated film type batteries of Examples 1-21 to 1-25 were fabricated in the same manners as in Examples 1-1 to 1-5, respectively, except that phosphomolybdic acid heptahydrate (formula (6)) was used in place of the phosphomolybdic acid 30-hydrate (formula (2)).

### Examples 1-26 to 1-30

Laminated film type batteries of Examples 1-26 to 1-30 were fabricated in the same manners as in Examples 1-1 to 1-5, respectively, except that silicomolybdic acid heptahydrate (formula (7)) was used in place of the phosphomolybdic acid 30-hydrate (formula (2)).

### Examples 1-31 to 1-35

Laminated film type batteries of Examples 1-31 to 1-35 were fabricated in the same manners as in Examples 1-1 to 1-5, respectively, except that phosphotungstic acid heptahydrate (formula (8)) was used in place of the phosphomolybdic acid 30-hydrate (formula (2)).

### Examples 1-36 to 1-40

Laminated film type batteries of Examples 1-36 to 1-40 were fabricated in the same manners as in Examples 1-1 to 1-5, respectively, except that silicotungstic acid heptahydrate (formula (9)) was used in place of the phosphomolybdic acid 30-hydrate (formula (2)).

### Examples 1-41 to 1-45

Laminated film type batteries of Examples 1-41 to 1-45 were fabricated in the same manners as in Examples 1-1 to 1-5, respectively, except that lithium silicotungstate (formula (10)) was used in place of the phosphomolybdic acid 30-hydrate (formula (2)).

### Examples 1-46 to 1-50

Laminated film type batteries of Examples 1-46 to 1-50 were fabricated in the same manners as in Examples 1-1 to 1-5, respectively, except that in the battery of Example 1-1 lithium cobalt complex oxide (LiCoO₂) was used in place of the lithium nickel complex oxide (LiNiO₂) as a positive electrode active material.

### Comparative Example 1-1

A laminated type battery of Comparative Example 1-1 was fabricated in the same manner as in Example 1-1, except that the phosphomolybdic acid 30-hydrate (formula (2)) was not used.

### Comparative Example 1-2

A laminated type battery of Comparative Example 1-2 was fabricated in the same manner as in Comparative Example 1-1, except that in the battery of Comparative Example 1-1, lithium cobalt complex oxide (LiCoO₂) was used in place of the lithium nickel complex oxide (LiNiO₂) as a positive electrode active material.

### Comparative Examples 1-3 to 1-7

Laminated type batteries of Comparative Examples 1-3 to 1-7 were fabricated in the same manners as in Examples 1-1 to 1-5, respectively, except that in the electrolytic solution of Example 1-1,4-fluoro-1,3-dioxolan-2-one (FEC) was used in place of the phosphomolybdic acid 30-hydrate (formula (2)).

### Comparative Examples 1-8 to 1-12

Laminated type batteries of Comparative Examples 1-8 to 1-12 were fabricated in the same manners as in Examples 1-1 to 1-5, respectively, except that in the electrolytic solution of Example 1-1, vinylene carbonate (VC) was used in place of the phosphomolybdic acid 30-hydrate (formula (2)).

### (Evaluation)

The laminated type batteries of Examples 1-1 to 1-50 and Comparative Examples 1-1 to 1-12 were subjected to a high-temperature cycle test as described below.

### (High-Temperature Cycle Test)

First of all, charge/discharge at a first cycle was carried out at 23° C., and charge/discharge at a second cycle was carried out in an atmosphere at 45° C., thereby measuring a discharge capacity at the second cycle. Subsequently, charge/discharge was carried out in the same atmosphere until a total sum of the cycle number reached 100 cycles, thereby measuring a discharge capacity at the 100th cycle. Finally, a high-temperature cycle retention rate was calculated according to the following expression.

High-temperature cycle retention rate (%)={(Discharge capacity at the 100th cycle)/(Discharge capacity at the second cycle)}×100(%)

Also, a thickness of the battery at each of the second cycle and the 100th cycle was measured, and a high-temperature cycle battery expansion rate was calculated according to the following expression.

High-temperature cycle battery expansion rate (%)=[{(Battery thickness at the 100th cycle)/(Battery thickness at the second cycle)}−1]×100(%)

Incidentally, as to a charge/discharge condition of one cycle, the battery was charged at a constant current of 840 mAh until the battery voltage reached a prescribed voltage (4.2 V); the battery was further charged at a constant voltage of a prescribed voltage until the current reached 42 mAh; and thereafter, the battery was discharged at a constant current of 840 mAh until the battery voltage reached 3 V.

The measurement results of the high-temperature cycle retention rate and the high-temperature cycle battery expansion rate are shown in Table 1.

TABLE 1

| | | | | High- | |
|---|---|---|---|---|---|
| | | | | temperature | |
| | Additive | | | cycle | |
| | | % by | Positive | retention rate | |
| | Kind | mass | electrode | (%) | |
| | | | | | High- |
| | | | | | temperature |
| | | | | | battery cycle |
| | | | | | expansion rate |
| | | | | | (%) |
| Example 1-1 | Formula (2) | 0.1 | LiNiO₂ | 47 | 14.3 |
| Example 1-2 | | 0.5 | | 62 | 7.4 |
| Example 1-3 | | 4.0 | | 75 | 5.6 |
| Example 1-4 | | 7.0 | | 81 | 4.5 |
| Example 1-5 | | 10.0 | | 80 | 4.6 |
| Example 1-6 | Formula (3) | 0.1 | LiNiO₂ | 49 | 14.5 |
| Example 1-7 | | 0.5 | | 58 | 7.8 |
| Example 1-8 | | 4.0 | | 78 | 5.0 |
| Example 1-9 | | 7.0 | | 81 | 4.3 |
| Example 1-10 | | 10.0 | | 80 | 4.4 |
| Example 1-11 | Formula (4) | 0.1 | LiNiO₂ | 46 | 14.1 |
| Example 1-12 | | 0.5 | | 60 | 7.7 |
| Example 1-13 | | 4.0 | | 73 | 5.3 |
| Example 1-14 | | 7.0 | | 78 | 4.5 |
| Example 1-15 | | 10.0 | | 77 | 4.4 |
| Example 1-16 | Formula (5) | 0.1 | LiNiO₂ | 49 | 13.9 |
| Example 1-17 | | 0.5 | | 63 | 7.5 |
| Example 1-18 | | 4.0 | | 72 | 5.5 |
| Example 1-19 | | 7.0 | | 79 | 4.0 |
| Example 1-20 | | 10.0 | | 80 | 4.2 |
| Example 1-21 | Formula (6) | 0.1 | LiNiO₂ | 50 | 12.7 |
| Example 1-22 | | 0.5 | | 63 | 6.3 |
| Example 1-23 | | 4.0 | | 76 | 3.8 |
| Example 1-24 | | 7.0 | | 83 | 3.0 |
| Example 1-25 | | 10.0 | | 82 | 3.1 |
| Example 1-26 | Formula (7) | 0.1 | LiNiO₂ | 52 | 13.0 |
| Example 1-27 | | 0.5 | | 61 | 6.5 |
| Example 1-28 | | 4.0 | | 78 | 3.8 |
| Example 1-29 | | 7.0 | | 83 | 2.9 |
| Example 1-30 | | 10.0 | | 82 | 3.0 |
| Example 1-31 | Formula (8) | 0.1 | LiNiO₂ | 48 | 12.5 |
| Example 1-32 | | 0.5 | | 62 | 6.4 |
| Example 1-33 | | 4.0 | | 77 | 3.7 |
| Example 1-34 | | 7.0 | | 81 | 3.2 |
| Example 1-35 | | 10.0 | | 82 | 3.1 |
| Example 1-36 | Formula (9) | 0.1 | LiNiO₂ | 50 | 12.9 |
| Example 1-37 | | 0.5 | | 65 | 6.3 |
| Example 1-38 | | 4.0 | | 74 | 3.8 |
| Example 1-39 | | 7.0 | | 82 | 2.6 |
| Example 1-40 | | 10.0 | | 81 | 2.9 |
| | | | | | High- |
| | | | | | temperature |
| | | | | | cycle battery |
| | | | | | expansion rate |
| | | | | | (%) |
| Example 1-41 | Formula | 0.1 | LiNiO₂ | 53 | 10.5 |
| Example 1-42 | (10) | 0.5 | | 65 | 5.8 |
| Example 1-43 | | 4.0 | | 81 | 3.4 |
| Example 1-44 | | 7.0 | | 84 | 3.1 |
| Example 1-45 | | 10.0 | | 83 | 2.9 |
| Example 1-46 | Formula (2) | 0.1 | LiCoO₂ | 46 | 14.6 |
| Example 1-47 | | 0.5 | | 59 | 7.5 |
| Example 1-48 | | 4.0 | | 70 | 6.0 |
| Example 1-49 | | 7.0 | | 76 | 5.1 |
| Example 1-50 | | 10.0 | | 73 | 4.8 |
| Comparative | — | — | LiNiO₂ | 43 | 29.8 |
| Example 1-1 | | | | | |
| Comparative | — | — | LiCoO₃ | 44 | 30.0 |
| Example 1-2 | | | | | |
| Comparative | FEC | 0.1 | LiNiO₂ | 46 | 24.3 |
| Example 1-3 | | | | | |
| Comparative | | 0.5 | | 54 | 15.8 |
| Example 1-4 | | | | | |
| Comparative | | 4.0 | | 54 | 16.0 |
| Example 1-5 | | | | | |
| Comparative | | 7.0 | | 48 | 21.9 |
| Example 1-6 | | | | | |
| Comparative | | 10.0 | | 32 | 36.5 |
| Example 1-7 | | | | | |
| Comparative | VC | 0.1 | LiNiO₂ | 49 | 25.0 |
| Example 1-8 | | | | | |
| Comparative | | 0.5 | | 56 | 14.9 |
| Example 1-9 | | | | | |
| Comparative | | 4.0 | | 55 | 14.0 |
| Example 1-10 | | | | | |
| Comparative | | 7.0 | | 44 | 22.0 |
| Example 1-11 | | | | | |
| Comparative | | 10.0 | | 36 | 35.8 |
| Example 1-12 | | | | | |

As shown in Table 1, according to Examples 1-1 to 1-45 and Comparative Example 1-1, in the case of using lithium nickelate (LiNiO₂) for the positive electrode, it was noted that by containing the heteropolyacid and/or the heteropolyacid compound together with the chain carboxylate with a total carbon number of 4 or more in the electrolytic solution, the high-temperature cycle retention rate and the high-temperature cycle battery expansion rate can be improved.

Also, according to Examples 1-46 to 1-50 and Comparative Example 1-2, in the case of using lithium cobaltate (LiCoO₂) for the positive electrode, it was noted that by containing the heteropolyacid and/or the heteropolyacid compound together with the chain carboxylate with a total carbon number of 4 or more in the electrolytic solution, the high-temperature cycle retention rate and the high-temperature cycle battery expansion rate can be improved. Also, according to Examples 1-1 to 1-50 and Comparative Examples 1-1 and 1-2, the improvement rate in the case of using lithium nickelate (LiNiO₂) for the positive electrode was higher than that in the case of using lithium cobaltate (LiCoO₂) for the positive electrode.

In Comparative Examples 1-3 to 1-7, FEC was used as a replacement of the heteropolyacid and/or the heteropolyacid compound together with the chain carboxylate with a total carbon number of 4 or more; and therefore, in Comparative Examples 1-3 to 1-7, the high-temperature cycle retention rate and the high-temperature cycle battery retention rate could not be improved as compared with those in the case of using the heteropolyacid and/or the heteropolyacid compound.

In Comparative Examples 1-8 to 1-12, VC was used as a replacement of the heteropolyacid and/or the heteropolyacid compound together with the chain carboxylate with a total carbon number of 4 or more; and therefore, in Comparative Examples 1-8 to 1-12, the high-temperature cycle retention rate and the high-temperature cycle battery retention rate could not be improved as compared with those in the case of using the heteropolyacid and/or the heteropolyacid compound.

### Example 2-1

A laminated type battery of Example 2-1 was fabricated in the same manner as in Example 1-1, except that as to the electrolytic solution, ethylene carbonate (EC), diethyl carbonate (DEC) and ethyl butyrate (EB) were mixed in a proportion of EC/DEC/EB of 40/59.9/0.1, the concentration of LiPF₆ was set to be 1 mole/kg, and furthermore, 0.1% by mass of silicotungstic acid heptahydrate (formula (5)) was added, thereby preparing an electrolytic solution.

### Example 2-2

A laminated type battery of Example 2-2 was fabricated in the same manner as in Example 2-1, except that at the preparation of the electrolytic solution, the addition amount of silicotungstic acid heptahydrate (formula (5)) was set to be 0.5% by mass.

### Example 2-3

A laminated type battery of Example 2-3 was fabricated in the same manner as in Example 2-1, except that at the preparation of the electrolytic solution, the addition amount of silicotungstic acid heptahydrate (formula (5)) was set to be 4.0% by mass.

### Example 2-4

A laminated type battery of Example 2-4 was fabricated in the same manner as in Example 2-1, except that at the preparation of the electrolytic solution, the addition amount of silicotungstic acid heptahydrate (formula (5)) was set to be 7.0% by mass.

### Example 2-5

A laminated type battery of Example 2-5 was fabricated in the same manner as in Example 2-1, except that at the preparation of the electrolytic solution, the addition amount of silicotungstic acid heptahydrate (formula (5)) was set to be 10.0% by mass.

### Examples 2-6 to 2-10

Laminated type batteries of Examples 2-6 to 2-10 were fabricated in the same manners as in Examples 2-1 to 2-5, respectively, except that at the preparation of the electrolytic solution, EC, DEC and EB were mixed in a proportion of EC/DEC/EB of 40/55/5.

### Examples 2-11 to 2-15

Laminated type batteries of Examples 2-11 to 2-15 were fabricated in the same manners as in Examples 2-1 to 2-5, respectively, except that at the preparation of the electrolytic solution, EC, DEC and EB were mixed in a proportion of EC/DEC/EB of 40/50/10.

### Examples 2-16 to 2-20

Laminated type batteries of Examples 2-16 to 2-20 were fabricated in the same manners as in Examples 2-1 to 2-5, respectively, except that at the preparation of the electrolytic solution, EC, DEC and EB were mixed in a proportion of EC/DEC/EB of 40/20/40.

### Examples 2-21 to 2-25

Laminated type batteries of Examples 2-21 to 2-25 were fabricated in the same manners as in Examples 2-1 to 2-5, respectively, except that at the preparation of the electrolytic solution, EC, DEC and EB were mixed in a proportion of EC/DEC/EB of 40/59.99/0.01.

### Examples 2-26 to 2-30

Laminated type batteries of Examples 2-26 to 2-30 were fabricated in the same manners as in Examples 2-1 to 2-5, respectively, except that at the preparation of the electrolytic solution, EC and EB were mixed in a proportion of EC/EB of 40/60.

### Comparative Example 2-1

A laminated type battery of Comparative Example 2-1 was fabricated in the same manner as in Example 2-1, except that as to the electrolytic solution, ethylene carbonate (EC), diethyl carbonate (DEC) and ethyl butyrate (EB) were mixed in a proportion of EC/DEC/EB of 40/59.9/0.1, and a concentration of LiPF₆ was set to be 1 mole/kg. Incidentally, silicotungstic acid heptahydrate (formula (5)) was not added.

### Comparative Example 2-2

A laminated type battery of Comparative Example 2-2 was fabricated in the same manner as in Comparative Example 2-1, except that at the preparation of the electrolytic solution, EC, DEC and EB were mixed in a proportion of EC/DEC/EB of 40/55/5.

### Comparative Example 2-3

A laminated type battery of Comparative Example 2-3 was fabricated in the same manner as in Comparative Example 2-1, except that at the preparation of the electrolytic solution, EC, DEC and EB were mixed in a proportion of EC/DEC/EB of 40/50/10.

### Comparative Example 2-4

A laminated type battery of Comparative Example 2-4 was fabricated in the same manner as in Comparative Example 2-1, except that at the preparation of the electrolytic solution, EC, DEC and EB were mixed in a proportion of EC/DEC/EB of 40/20/40.

### Comparative Example 2-5

A laminated type battery of Comparative Example 2-5 was fabricated in the same manner as in Comparative Example 2-1, except that at the preparation of the electrolytic solution, EC, DEC and EB were mixed in a proportion of EC/DEC/EB of 40/59.99/0.01.

### Comparative Example 2-6

A laminated type battery of Comparative Example 2-6 was fabricated in the same manner as in Comparative Example 2-1, except that at the preparation of the electrolytic solution, EC and EB were mixed in a proportion of EC/EB of 40/60.

### Comparative Example 2-7

A laminated type battery of Comparative Example 2-7 was fabricated in the same manner as in Comparative Example 2-1, except that at the preparation of the electrolytic solution, 1,2-dimethoxyethane (DME) was used in placed of EB, and EC, DEC and DME were mixed in a proportion of EC/DEC/DME of 40/40/20.

### Comparative Example 2-8

A laminated type battery of Comparative Example 2-8 was fabricated in the same manner as in Comparative Example 2-7, except that at the preparation of the electrolytic solution, the addition amount of silicotungstic acid heptahydrate (formula (5)) was set to be 0.5% by mass.

### Comparative Example 2-9

A laminated type battery of Comparative Example 2-9 was fabricated in the same manner as in Comparative Example 2-7, except that at the preparation of the electrolytic solution, the addition amount of silicotungstic acid heptahydrate (formula (5)) was set to be 4.0% by mass.

### Comparative Example 2-10

A laminated type battery of Comparative Example 2-10 was fabricated in the same manner as in Comparative Example 2-7, except that at the preparation of the electrolytic solution, the addition amount of silicotungstic acid heptahydrate (formula (5)) was set to be 7.0% by mass.

### Comparative Example 2-11

A laminated type battery of Comparative Example 2-11 was fabricated in the same manner as in Comparative Example 2-7, except that at the preparation of the electrolytic solution, the addition amount of silicotungstic acid heptahydrate (formula (5)) was set to be 10.0% by mass.

### Comparative Example 2-12

A laminated type battery of Comparative Example 2-12 was fabricated in the same manner as in Comparative Example 2-1, except that at the preparation of the electrolytic solution, EC and DEC were mixed in a proportion of EC/DEC of 40/60.

### Comparative Example 2-13

A laminated type battery of Comparative Example 2-13 was fabricated in the same manner as in Comparative Example 2-12, except that at the preparation of the electrolytic solution, the addition amount of silicotungstic acid heptahydrate (formula (5)) was set to be 0.1% by mass.

### Comparative Example 2-14

A laminated type battery of Comparative Example 2-14 was fabricated in the same manner as in Comparative Example 2-12, except that at the preparation of the electrolytic solution, the addition amount of silicotungstic acid heptahydrate (formula (5)) was set to be 0.5% by mass.

### Comparative Example 2-15

A laminated type battery of Comparative Example 2-15 was fabricated in the same manner as in Comparative Example 2-12, except that at the preparation of the electrolytic solution, the addition amount of silicotungstic acid heptahydrate (formula (5)) was set to be 4.0% by mass.

### Comparative Example 2-16

A laminated type battery of Comparative Example 2-16 was fabricated in the same manner as in Comparative Example 2-12, except that at the preparation of the electrolytic solution, the addition amount of silicotungstic acid heptahydrate (formula (5)) was set to be 7.0% by mass.

### Comparative Example 2-17

A laminated type battery of Comparative Example 2-17 was fabricated in the same manner as in Comparative Example 2-12, except that at the preparation of the electrolytic solution, the addition amount of silicotungstic acid heptahydrate (formula (5)) was set to be 10.0% by mass.

### (Evaluation)

The laminated type batteries of Examples 2-1 to 2-30 and Comparative Examples 2-1 to 2-17 were subjected to a high-temperature cycle test in the same manner as in Example 1-1. The measurement results of the high-temperature cycle retention rate and the high-temperature cycle battery expansion rate are shown in Table 2. Incidentally, in order to make Examples 1-21 to 1-25 and Comparative Example 1-1 subjective to the evaluation, too, the measurement results of Examples 1-21 to 1-25 and Comparative Example 1-1 are also shown in Table 2.

TABLE 2

| | | | Heteropolyacid | | | High-temperature |
|---|---|---|---|---|---|---|
| | Carboxylate | | compound | | High-temperature | battery cycle |
| | | *Composition | | % by | cycle retention | expansion |
| | Kind | ratio x | Kind | mass | rate (%) | rate (%) |
| Example 2-1 | EB | 0.1 | Formula | 0.1 | 59 | 10.4 |
| Example 2-2 | | | (5) | 0.5 | 66 | 8.8 |
| Example 2-3 | | | | 4.0 | 69 | 7.7 |
| Example 2-4 | | | | 7.0 | 65 | 10.2 |
| Example 2-5 | | | | 10.0 | 45 | 19.0 |
| Example 2-6 | | 5.0 | | 0.1 | 64 | 8.8 |
| Example 2-7 | | | | 0.5 | 78 | 4.1 |
| Example 2-8 | | | | 4.0 | 83 | 3.2 |
| Example 2-9 | | | | 7.0 | 79 | 4.5 |
| Example 2-10 | | | | 10.0 | 65 | 10.4 |
| Example 2-11 | | 10.0 | | 0.1 | 69 | 7.8 |
| Example 2-12 | | | | 0.5 | 75 | 4.8 |
| Example 2-13 | | | | 4.0 | 82 | 3.3 |
| Example 2-14 | | | | 7.0 | 84 | 3.0 |
| Example 2-15 | | | | 10.0 | 74 | 3.9 |
| Example 1-21 | | 20.0 | | 0.1 | 50 | 12.7 |
| Example 1-22 | | | | 0.5 | 63 | 6.3 |
| Example 1-23 | | | | 4.0 | 76 | 3.8 |
| Example 1-24 | | | | 7.0 | 83 | 3.0 |
| Example 1-25 | | | | 10.0 | 82 | 3.1 |
| Example 2-16 | | 40.0 | | 0.1 | 35 | 16.0 |
| Example 2-17 | | | | 0.5 | 45 | 9.5 |
| Example 2-18 | | | | 4.0 | 67 | 6.1 |
| Example 2-19 | | | | 7.0 | 73 | 4.3 |
| Example 2-20 | | | | 10.0 | 79 | 3.2 |
| Example 2-21 | | 0.01 | | 0.1 | 51 | 11.4 |
| Example 2-22 | | | | 0.5 | 52 | 9.4 |
| Example 2-23 | | | | 4.0 | 59 | 8.0 |
| Example 2-24 | | | | 7.0 | 50 | 10.5 |
| Example 2-25 | | | | 10.0 | 38 | 19.1 |
| Example 2-26 | | 60.0 | | 0.1 | 30 | 28.6 |
| Example 2-27 | | | | 0.5 | 42 | 20.8 |
| Example 2-28 | | | | 4.0 | 55 | 13.2 |
| Example 2-29 | | | | 7.0 | 61 | 9.8 |
| Example 2-30 | | | | 10.0 | 61 | 9.7 |
| Comparative | EB | 0.1 | — | — | 53 | 17.0 |
| Example 2-1 | | | | | | |
| Comparative | | 5 | | | 59 | 19.8 |
| Example 2-2 | | | | | | |
| Comparative | | 10 | | | 61 | 25.4 |
| Example 2-3 | | | | | | |
| Comparative | | 20 | | | 43 | 29.8 |
| Example 1-1 | | | | | | |
| Comparative | | 40 | | | 28 | 36.8 |
| Example 2-4 | | | | | | |
| Comparative | | 0.01 | | | 51 | 16.0 |
| Example 2-5 | | | | | | |
| Comparative | | 60 | | | 20 | 40.5 |
| Example 2-6 | | | | | | |
| Comparative | DME | 20.0 | Formula | 0.1 | 41 | 15.4 |
| Example 2-7 | | | (5) | | | |
| Comparative | | | | 0.5 | 52 | 9.7 |
| Example 2-8 | | | | | | |
| Comparative | | | | 4.0 | 60 | 7.5 |
| Example 2-9 | | | | | | |
| Comparative | | | | 7.0 | 65 | 6.9 |
| Example 2-10 | | | | | | |
| Comparative | | | | 10.0 | 66 | 7.0 |
| Example 2-11 | | | | | | |
| Comparative | — | — | — | — | 50 | 15.7 |
| Example 2-12 | | | | | | |
| Comparative | — | — | Formula | 0.1 | 52 | 11.6 |
| Example 2-13 | | | (5) | | | |
| Comparative | | | | 0.5 | 57 | 9.1 |
| Example 2-14 | | | | | | |
| Comparative | | | | 4.0 | 61 | 7.8 |
| Example 2-15 | | | | | | |
| Comparative | | | | 7.0 | 50 | 10.2 |
| Example 2-16 | | | | | | |
| Comparative | | | | 10.0 | 37 | 18.8 |
| Example 2-17 | | | | | | |

*Solvent composition ratio: EC/DEC/EB or DME = 40/(60 − x)/x

It is noted from Table 2 that as the amount of the chain carboxylate with a total carbon number of 4 or more increases, even in the case of adding a large amount of the heteropolyacid and/or the heteropolyacid compound, excellent effects are revealed. It may be considered that this is caused due to the matter that the chain carboxylate with a total carbon number of 4 or more having a low viscosity accelerates the movement of the heteropolyacid compound, and therefore, even by using a relatively large amount of the heteropolyacid and/or the heteropolyacid compound, a uniform SEI is formed on the negative electrode surface.

According to Examples 2-1 to 2-30, it was noted that the chain carboxylate with a total carbon number of 4 or more is contained preferably in an amount of 0.1% by mass or more and not more than 40% by mass, and more preferably in an amount of 5% by mass or more and not more than 40% by mass. According to the comparison between Examples 1-21 to 1-25 and Comparative Examples 2-7 to 2-11, it was noted that even when compared with other low-viscosity solvents, the case of using the chain carboxylate with a total carbon number of 4 or more is preferable.

### Example 3-1

A laminated type battery of Example 3-1 was fabricated in the same manner as in Example 1-1, except that as to the electrolytic solution, ethylene carbonate (EC), diethyl carbonate (DEC) and ethyl acetate (EA) were mixed in a proportion of EC/DEC/EA of 40/40/20, the concentration of LiPF₆ was set to be 1 mole/kg, and furthermore, 4.0% by mass of silicotungstic acid heptahydrate (formula (5)) was added, thereby preparing an electrolytic solution.

### Example 3-2

A laminated type battery of Example 3-2 was fabricated in the same manner as in Example 3-1, except that at the preparation of the electrolytic solution, the addition amount of silicotungstic acid heptahydrate (formula (5)) was set to be 7.0% by mass.

### Examples 3-3 to 3-4

Laminated type batteries of Examples 3-3 to 3-4 were fabricated in the same manners as in Examples 3-1 to 3-2, respectively, except that in each of the electrolytic solutions of Examples 3-1 and 3-2, ethyl propionate (EP) was used in place of the ethyl acetate.

### Examples 3-5 to 3-6

Laminated type batteries of Examples 3-5 to 3-6 were fabricated in the same manners as in Examples 3-1 to 3-2, respectively, except that in each of the electrolytic solutions of Examples 3-1 and 3-2, butyl acetate (BA) was used in place of the ethyl acetate.

### Examples 3-7 to 3-8

Laminated type batteries of Examples 3-7 to 3-8 were fabricated in the same manners as in Examples 3-1 to 3-2, respectively, except that in each of the electrolytic solutions of Examples 3-1 and 3-2, ethyl isobutyrate (EIB) was used in place of the ethyl acetate.

### Examples 3-9 to 3-10

Laminated type batteries of Examples 3-9 to 3-10 were fabricated in the same manners as in Examples 3-1 to 3-2, respectively, except that in each of the electrolytic solutions of Examples 3-1 and 3-2, ethyl valerate (EV) was used in place of the ethyl acetate.

### Examples 3-11 to 3-12

Laminated type batteries of Examples 3-11 to 3-12 were fabricated in the same manners as in Examples 3-1 to 3-2, respectively, except that in each of the electrolytic solutions of Examples 3-1 and 3-2, ethyl 2-methylbutyrate (MEB) was used in place of the ethyl acetate.

### Examples 3-13 to 3-14

Laminated type batteries of Examples 3-13 to 3-14 were fabricated in the same manners as in Examples 3-1 to 3-2, respectively, except that in each of the electrolytic solutions of Examples 3-1 and 3-2, propyl isovalerate (PIV) was used in place of the ethyl acetate.

### Comparative Example 3-1

A laminated type battery of Comparative Example 3-1 was fabricated in the same manner as in Example 3-1, except that as to the electrolytic solution, ethylene carbonate (EC), diethyl carbonate (DEC) and methyl acetate (MA) were mixed in a proportion of EC/DEC/MA of 40/40/20, and a concentration of LiPF₆ was set to be 1 mole/kg. Incidentally, silicotungstic acid heptahydrate (formula (5)) was not added.

### Comparative Example 3-2

A laminated type battery of Comparative Example 3-2 was fabricated in the same manner as in Comparative Example 3-1, except that at the preparation of the electrolytic solution, the addition amount of silicotungstic acid heptahydrate (formula (5)) was set to be 4.0% by mass.

### Comparative Example 3-3

A laminated type battery of Comparative Example 3-3 was fabricated in the same manner as in Comparative Example 3-1, except that at the preparation of the electrolytic solution, the addition amount of silicotungstic acid heptahydrate (formula (5)) was set to be 7.0% by mass.

### Comparative Example 3-4

A laminated type battery of Comparative Example 3-4 was fabricated in the same manner as in Example 3-1, except that in the electrolytic solution of Example 3-1, silicotungstic acid heptahydrate (formula (5)) was not added, thereby preparing an electrolytic solution.

### Comparative Example 3-5

A laminated type battery of Comparative Example 3-5 was fabricated in the same manner as in Example 3-3, except that in the electrolytic solution of Example 3-3, silicotungstic acid heptahydrate (formula (5)) was not added, thereby preparing an electrolytic solution.

### Comparative Example 3-6

A laminated type battery of Comparative Example 3-6 was fabricated in the same manner as in Example 3-5, except that in the electrolytic solution of Example 3-5, silicotungstic acid heptahydrate (formula (5)) was not added, thereby preparing an electrolytic solution.

### Comparative Example 3-7

A laminated type battery of Comparative Example 3-7 was fabricated in the same manner as in Example 3-7, except that in the electrolytic solution of Example 3-7, silicotungstic acid heptahydrate (formula (5)) was not added, thereby preparing an electrolytic solution.

### Comparative Example 3-8

A laminated type battery of Comparative Example 3-8 was fabricated in the same manner as in Example 3-9, except that in the electrolytic solution of Example 3-9, silicotungstic acid heptahydrate (formula (5)) was not added, thereby preparing an electrolytic solution.

### Comparative Example 3-9

A laminated type battery of Comparative Example 3-9 was fabricated in the same manner as in Example 3-11, except that in the electrolytic solution of Example 3-11, silicotungstic acid heptahydrate (formula (5)) was not added, thereby preparing an electrolytic solution.

### Comparative Example 3-10

A laminated type battery of Comparative Example 3-10 was fabricated in the same manner as in Example 3-13, except that in the electrolytic solution of Example 3-13, silicotungstic acid heptahydrate (formula (5)) was not added, thereby preparing an electrolytic solution.

### (Evaluation)

The laminated type batteries of Examples 3-1 to 3-14 and Comparative Examples 3-1 to 3-10 were subjected to a high-temperature cycle test in the same manner as in Example 1-1. The measurement results of the high-temperature cycle retention rate and the high-temperature cycle battery expansion rate are shown in Table 3. Incidentally, in order to make Examples 1-23 to 1-24 and Comparative Example 1-1 subjective to the evaluation, too, the measurement results of Examples 1-23 to 1-24 and Comparative Example 1-1 are also shown in Table 3.

TABLE 3

| | | | | High- | |
|---|---|---|---|---|---|
| | | Hetero- | | tempera- | High- |
| | | polyacid | | ture | temperature |
| | | compound | | cycle | battery cycle |
| | Carboxylate | | % by | retention | expansion |
| | Kind | Kind | mass | rate (%) | rate (%) |
| Example 3-1 | EA | Formula | 4.0 | 67 | 12.9 |
| Example 3-2 | | (5) | 7.0 | 76 | 5.7 |
| Example 3-3 | EP | | 4.0 | 71 | 7.8 |
| Example 3-4 | | | 7.0 | 81 | 4.0 |
| Example 1-23 | EB | | 4.0 | 76 | 3.8 |
| Example 1-24 | | | 7.0 | 83 | 3.0 |
| Example 3-5 | BA | | 4.0 | 78 | 3.9 |
| Example 3-6 | | | 7.0 | 85 | 2.9 |
| Example 3-7 | EIB | | 4.0 | 74 | 4.1 |
| Example 3-8 | | | 7.0 | 86 | 3.2 |
| Example 3-9 | EV | | 4.0 | 76 | 6.5 |
| Example 3-10 | | | 7.0 | 70 | 7.8 |
| Example 3-11 | MEB | | 4.0 | 73 | 6.8 |
| Example 3-12 | | | 7.0 | 67 | 7.5 |
| Example 3-13 | PIV | | 4.0 | 65 | 8.1 |
| Example 3-14 | | | 7.0 | 55 | 14.5 |
| Comparative | MA | Formula | 0.0 | 28 | 38.9 |
| Example 3-1 | | (5) | | | |
| Comparative | | | 4.0 | 54 | 18.7 |
| Example 3-2 | | | | | |
| Comparative | | | 7.0 | 56 | 14.3 |
| Example 3-3 | | | | | |
| Comparative | EA | — | — | 34 | 34.5 |
| Example 3-4 | | | | | |
| Comparative | EP | | | 39 | 31.1 |
| Example 3-5 | | | | | |
| Comparative | EB | | | 43 | 29.8 |
| Example 1-1 | | | | | |
| Comparative | BA | | | 45 | 28.6 |
| Example 3-6 | | | | | |
| Comparative | EIB | | | 41 | 31.0 |
| Example 3-7 | | | | | |
| Comparative | EV | | | 48 | 24.8 |
| Example 3-8 | | | | | |
| Comparative | MEB | | | 49 | 26.5 |
| Example 3-9 | | | | | |
| Comparative | PIV | | | 55 | 22.1 |
| Example 3-10 | | | | | |

As shown in Table 3, according to Examples 3-1 to 3-14 and Examples 1-23 to 1-24, it was noted that the improvement effect in the high-temperature cycle characteristic to be brought by the heteropolyacid and/or the heteropolyacid compound does not reply upon the kind of the chain carboxylate. Also, according to Examples 3-1 to 3-14, Examples 1-23 to 1-24 and Comparative Examples 3-1 to 3-3, it was noted that the total carbon number of the chain carboxylate to be contained is preferably 4 or more, and more preferably 4 or more and not more than 7.

### 6. Other Embodiments

It should not be construed that the technologies of the present disclosure are limited to the foregoing embodiments according to the present disclosure, and various modifications and applications can be made therein so far as the gist of the technologies of the present disclosure is not deviated. For example, in the foregoing embodiments and working examples, the batteries having a laminated film type or cylindrical type battery structure, the batteries having a wound structure in which the electrodes are wound and the batteries of a stack type having a structure in which the electrodes are stacked have been described, but it should not be construed that the technologies of the present disclosure are limited thereto. For example, the technologies of the present disclosure can be similarly applied to batteries having other battery structure such as a rectangular type, a coin type and a button type, and the same effects can be obtained.

The present disclosure contains subject matter related to that disclosed in Japanese Priority Patent Application JP 2010-154709 filed in the Japan Patent Office on Jul. 7, 2010, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A nonaqueous electrolyte battery comprising:
a positive electrode;
a negative electrode; and
a nonaqueous electrolyte,
wherein the nonaqueous electrolyte contains
a solvent,
an electrolyte salt, and
a polyacid and/or a polyacid compound, and
the solvent contains a chain carboxylate with a total carbon number of 4 or more.

2. The nonaqueous electrolyte battery according to claim 1, wherein the polyacid and/or the polyacid compound is a heteropolyacid and/or a heteropolyacid compound.

3. The nonaqueous electrolyte battery according to claim 2, wherein the heteropolyacid and/or the heteropolyacid compound is a compound represented by the following formula (I)
Aₓ[BD₁₂O₄₀].yH₂O Formula (1)
wherein
A represents H, Li, Na, K, Rb, Cs, Mg, Ca, Al, NH₄, a quaternary ammonium salt or a phosphonium salt; B represents P, Si, As or Ge; D represents at least one element selected from the group consisting of Ti, V, Cr, Mn, Fe, Co, Ni, Cu, Zn, Ga, Zr, Nb, Mo, Tc, Rh, Cd, In, Sn, Ta, W, Re and Tl; and x and y are values falling within the ranges of (0≦x≦7) and (0≦y≦50), respectively.

4. The nonaqueous electrolyte battery according to claim 1, wherein the polyacid and/or the polyacid compound is a heteropolyacid and/or a heteropolyacid compound having two or more kinds of polyelements.

5. The nonaqueous electrolyte battery according to claim 1, wherein the chain carboxylate with a total carbon number of 4 or more is a chain carboxylate represented by the following formula (1) 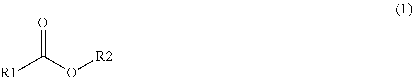
wherein
each of R1 and R2 independently represents a hydrocarbon group; the hydrocarbon group may be branched; and a total sum of the carbon number of R1 and R2 is 3 or more and not more than 6.

6. The nonaqueous electrolyte battery according to claim 1, wherein a content of the polyacid and/or the polyacid compound is 0.1% by mass or more and not more than 10% by mass.

7. The nonaqueous electrolyte battery according to claim 1, wherein a content of the chain carboxylate compound with a total carbon number of 4 or more is 0.1% by mass or more and not more than 40% by mass.

8. The nonaqueous electrolyte battery according to claim 1, wherein the nonaqueous electrolyte is an electrolyte in a gel form.

9. A nonaqueous electrolyte battery comprising:
a positive electrode;
a negative electrode; and
a nonaqueous electrolyte containing a solvent and an electrolyte salt,
wherein the solvent contains a chain carboxylate with a total carbon number of 4 or more, and
a coating in a gel form containing an amorphous polyacid and/or polyacid compound having one or more kinds of polyelements are formed on the negative electrode.

10. The nonaqueous electrolyte battery according to claim 9, wherein the coating in a gel form contains the amorphous polyacid and/or polyacid compound having a three-dimensional network structure and the nonaqueous electrolyte.

11. A nonaqueous electrolyte battery comprising:
a positive electrode;
a negative electrode; and
a nonaqueous electrolyte containing a solvent and an electrolyte salt,
wherein the solvent contains a chain carboxylate with a total carbon number of 4 or more, and
a polyacid and/or a polyacid compound is contained in the inside of the battery.

12. The nonaqueous electrolyte battery according to claim 11, further including a separator,
wherein at least one of the positive electrode, the negative electrode, the nonaqueous electrolyte and the separator contains the polyacid and/or the polyacid compound.

13. A nonaqueous electrolyte comprising:
a solvent;
an electrolyte salt; and
a polyacid and/or a polyacid compound,
wherein the solvent contains a chain carboxylate with a total carbon number of 4 or more.
